(19) United States
(12) Patent Application Publication
(10) Pub. No.: US 2026/0153358 A1
(43) Pub. Date: Jun. 4, 2026

(54) SYSTEMS AND METHODS FOR OBTAINING A REPRESENTATION OF MAGNITUDE OF A SENSED MAGNETIC FIELD

(71) Applicant: Allegro MicroSystems, LLC, Manchester, NH (US)

(72) Inventors: Alfredo A. Falcón, Buenos Aires (AR); Franco Noel Martin Pirchio, Buenos Aires (AR)

(73) Assignee: Allegro MicroSystems, LLC, Manchester, NH (US)

(21) Appl. No.: 18/965,280

(22) Filed: Dec. 2, 2024

(51) Int. Cl. G01D 5/14

(52) U.S. Cl. CPC G01D 5/14

(57) ABSTRACT

Disclosed are example systems and methods for obtaining a representation of magnitude of a magnetic field as sensed by a sensor device. In particular, described are example systems and methods for obtaining a squared modulus value representative of magnitude of a magnetic field as sensed by a sensor device. In some embodiments, amplitudes of signals representing a magnetic field generated by a target may be sampled by the sensor device, and pulse width modulated (PWM) signals representative of the amplitudes may be generated. A double integration of a constant value over the widths of the PWM signals may then be performed, and the results of the double integrations added to obtain a squared modulus value representative of a magnitude of the magnetic field as sensed by the sensor device.

### BACKGROUND

Sensor devices are often used to monitor parameters of a system. For example, sensor devices may be used to measure an angle of rotation of a rotation object, such as of a rotor of an electric motor. The measured angle information may then be used to control the motor. For example, a controller may continuously receive a measured angle of rotation of the rotor, and may use this information to commutate the motor. That is, the measured angle information may be used by the controller to switch currents in motor windings, producing magnetic fields that cause the rotor to rotate. The controller can then control aspects of the motor, such as speed and torque, based on the measured angle information. Numerous applications in industries, spanning from industrial automation and robotics, to electronic power steering and motor position sensing, may require monitoring of a rotation angle of a rotating shaft.

### SUMMARY

Disclosed are example systems and methods for obtaining a representation of magnitude of a magnetic field as sensed by a sensor device. In particular, described are example systems and methods for obtaining a squared modulus value representative of magnitude of a magnetic field as sensed by a sensor device. In some embodiments, amplitudes of signals representing a magnetic field generated by a target may be sampled by the sensor device, and pulse width modulated (PWM) signals representative of the amplitudes may be generated. A double integration of a constant value over the widths of the PWM signals may then be performed, and the results of the double integrations added to obtain the squared modulus value. The squared modulus value may represent the magnitude of the magnetic field as sensed by the sensor device. In some embodiments, the squared modulus value may be used for controlling the gain of one or more signal paths in the sensor device. In some embodiments, the squared modulus value may be output from the sensor device for use by another system. In some embodiments, the squared modulus value may be used to determine whether an error condition has occurred in sensing the magnetic field.

In accordance with some embodiments, there is provided a method of obtaining a value representative of magnetic field strength. The method comprises sampling amplitudes of a plurality of signals representing a magnetic field associated with a target at a first time, and generating pulse width modulated (PWM) signals with widths representative of the sampled amplitudes. The method also comprises performing a double integration of a constant value over the widths of the PWM signals. The method further comprises adding results of the double integrations to obtain a value representative of a magnitude of the magnetic field strength, and outputting the value.

In some embodiments, the method further comprises sampling the amplitudes of the plurality of signals with zero order hold circuits.

In further embodiments, the PWM signals are generated by comparing the sampled amplitudes with one or more voltage ramp signals.

In still further embodiments, the double integrations are performed by one or more circuits, the one or more circuits comprising capacitors, a current source, a transconductance components, and a plurality of switches.

In some embodiments, the double integrations are performed digitally by a digital controller.

In further embodiments, the double integrations are performed simultaneously with the generation of the PWM signals.

In some embodiments, the method further comprises receiving a signal to adjust a gain of the plurality of signals in response to the value.

In further embodiments, the method further comprises outputting an error signal when an amplitude of each of the PWM signals is zero at the same time.

In still further embodiments, the method further comprises outputting an error signal when the obtained value is either greater than a first predetermined value or less than a second predetermined value.

In some embodiments, the method further comprises setting a common mode reference voltage.

In further embodiments, the PWM signals are further generated by comparing the one or more voltage ramp signals with the common mode reference voltage.

Furthermore, in accordance with some embodiments, there is provided a system comprising electronic circuitry. The electronic circuitry is configured to sample amplitudes of a plurality of signals representing a magnetic field associated with a target at a first time, and generate pulse width modulated (PWM) signals with widths representative of the sampled amplitudes. The electronic circuitry is also configured to perform a double integration of a constant value over the widths of the PWM signals. The electronic circuitry is further configured to add results of the double integrations to obtain a value representative of a magnitude of a strength of the magnetic field, and to output the value.

In some embodiments, the electronic circuitry further comprises zero hold circuits configured to sample the amplitudes of the plurality of signals.

In further embodiments, the electronic circuitry further comprises voltage-to-time conversion circuits configured to compare the sampled amplitudes with one or more voltage ramp signals to generate the PWM signals.

In still further embodiments, the electronic circuitry further comprises one or more circuits configured to perform the double integrations, the one or more circuits comprising capacitors, a current source, a transconductance component, and a plurality of switches.

In some embodiments, the electronic circuitry further comprises a digital controller, the digital controller configured to perform the double integrations.

In further embodiments, the electronic circuitry is further configured to receive a signal to adjust a gain of the plurality of signals in response to the value.

In still further embodiments, the electronic circuitry is further configured to cause an error signal to be output when an amplitude of each of the PWM signals is zero at the same time.

In some embodiments, the electronic circuitry is further configured to cause an error signal to be output when the obtained value is either greater than a first predetermined value or less than a second predetermined value.

In further embodiments, the electronic circuitry is further configured to set a common mode reference voltage.

In still further embodiments, the electronic circuitry is further configured to generate the PWM signals by comparing the one or more voltage ramp signals with the common mode reference voltage.

Additionally, in accordance with some embodiments, there is provided a non-transitory computer-readable medium storing instructions that, when executed by the processor, configure the processor to perform a method. The method comprises receiving pulse width modulated (PWM) signals with widths representative of a magnitude of a magnetic field of a target, and performing a double integration of a constant value over the widths of the PWM signals. The method also comprises adding the results of the double integrations to obtain a value representative of a magnitude of a strength of the magnetic field, and outputting the value.

In some embodiments, the processor is further configured to perform the double integrations.

In further embodiments, the processor is further configured to output an error signal when an amplitude of each of the PWM signals is zero at the same time.

In still further embodiments, the processor is further configured to output an error signal when the obtained value is either greater than a first predetermined value or less than a second predetermined value.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings are incorporated in and constitute part of this specification. The drawings, together with the description, illustrate and serve to explain the principles of various example embodiments of the disclosure.

FIG. 1 shows an example system with an on-axis arrangement for detecting rotation angles of a target.

FIG. 2A shows a block diagram of an example sensor device, consistent with embodiments of the present disclosure.

FIG. 2B shows a block diagram of another example sensor device, consistent with embodiments of the present disclosure.

FIG. 2C shows a block diagram of example magnetic field sensing elements and example circuitry, consistent with embodiments of the present disclosure.

FIG. 2D shows an example arrangement of magnetic field sensing elements for the sensor device shown in FIG. 2C.

FIG. 3A shows a graph of example sine and cosine signals obtained by a sensor device.

FIG. 3B shows another graph of example sine and cosine signals obtained by a sensor device.

FIG. 4 shows a block diagram of an example system for obtaining a squared modulus value that is representative of a magnitude of a magnetic field as sensed by a sensor device, consistent with embodiments of the present disclosure.

FIG. 5 shows another block diagram of an example system for obtaining a squared modulus value that is representative of a magnitude of a magnetic field as sensed by a sensor device, consistent with embodiments of the present disclosure.

FIG. 6 shows a graph of an example voltage-to-time conversion process, consistent with embodiments of the present disclosure.

FIG. 7 shows a block diagram of an example system for performing a double integration of a constant value over a time derived from a voltage-to-time conversion process, consistent with embodiments of the present disclosure.

FIG. 8 shows graphs, including a graph of an example voltage ramp signal, a graph of an example reset signal, a graph of an example input sample signal, a graph of an example output sample signal, graphs of example pulse-width modulated (PWM) time signals generated as a result of voltage-to-time conversion processes, and graphs of example signals resulting from double integrations of the PWM time signals, consistent with embodiments of the present disclosure.

FIG. 9A shows a graph of a first example signal corresponding to a measured magnetic field by one or more magnetic field sensing elements, and an example first sample from the first example signal.

FIG. 9B shows a graph of a second example signal corresponding to a measured magnetic field by one or more additional magnetic field sensing elements, and an example second sample from the second example signal.

FIG. 9C shows graphs, including a graph of an amplitude of the first sample from the first example signal, a graph of example signals for sampling the first example signal and for sampling an output signal, a graph of a voltage ramp and the amplitude of the first sample, a graph of an example first PWM time signal generated as a result of a voltage-to-time conversion process, a graph of a signal resulting from a first integration of the example first PWM time signal, and a graph of a signal resulting from a second integration of the example first PWM time signal.

FIG. 9D shows graphs, including a graph of an amplitude of the second sample from the second example signal, a graph of example signals for sampling the second example signal and for sampling an output signal, a graph of a voltage ramp and the amplitude of the second sample, a graph of an example second PWM time signal generated as a result of a voltage-to-time conversion process, a graph of a signal resulting from a first integration of the example second PWM time signal, and a graph of a signal resulting from a second integration of the example second PWM time signal.

FIG. 9E shows a graph of the first example signal and first sample of FIG. 9A, the second example signal and second sample of FIG. 9B, and the obtained squared modulus value over a full rotation of the target.

FIG. 10A shows graphs, including a graph of a first example signal corresponding to a measured magnetic field by one or more magnetic field sensing elements and an example first sample from the first example signal, a graph of example signals for sampling the first example signal and for sampling output signals, a graph of voltage ramps and sampled amplitudes of the first example signal, a graph of example PWM time signals generated as a result of voltage-to-time conversion processes, a graph of signals resulting from first integrations of the PWM time signals, and a graph of signals resulting from second integrations of the PWM time signals.

FIG. 10B shows graphs, including a graph of a second example signal corresponding to a measured magnetic field by one or more magnetic field sensing elements and an example first sample from the second example signal, a graph of example signals for sampling the second example signal and for sampling output signals, a graph of voltage ramps and sampled amplitudes of the second example signal, a graph of example PWM time signals generated as a result of voltage-to-time conversion processes, a graph of signals resulting from first integrations of the PWM time signals, and a graph of signals resulting from second integrations of the PWM time signals.

FIG. 11 shows an example process for obtaining a representation of magnitude of a magnetic field as sensed by a sensor device, consistent with embodiments of the present disclosure.

FIG. 12 shows an example computing environment, consistent with embodiments of the present disclosure.

FIG. 13 shows an example computing device, consistent with embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Reference will now be made in detail to the embodiments of the disclosure, certain examples of which are illustrated in the accompanying drawings.

In the following description, numerous specific details are set forth regarding the systems and methods of the disclosed subject matter, and the environment in which such systems and methods operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the systems and methods described herein. In addition, it will be understood that the embodiments provided below are examples, and that it is contemplated that there are other systems and methods that are within the scope of the subject matter disclosed herein.

A magnetic field sensor device may be used to determine a rotation angle of a rotation object. With a magnetic field sensor device, one or more elements of the sensor device that are responsive to a magnetic field may be positioned near a rotation object and may either directly detect a magnetic field generated by the rotation object (e.g., if the rotation object is magnetized) or detect a magnetic field of a magnet attached to the rotation object.

An object monitored by a sensor device is often referred to as a target. Accordingly, an object whose characteristics are sensed by the sensor device, such as a magnet or magnetized rotation object, may be referred to as a “target” herein.

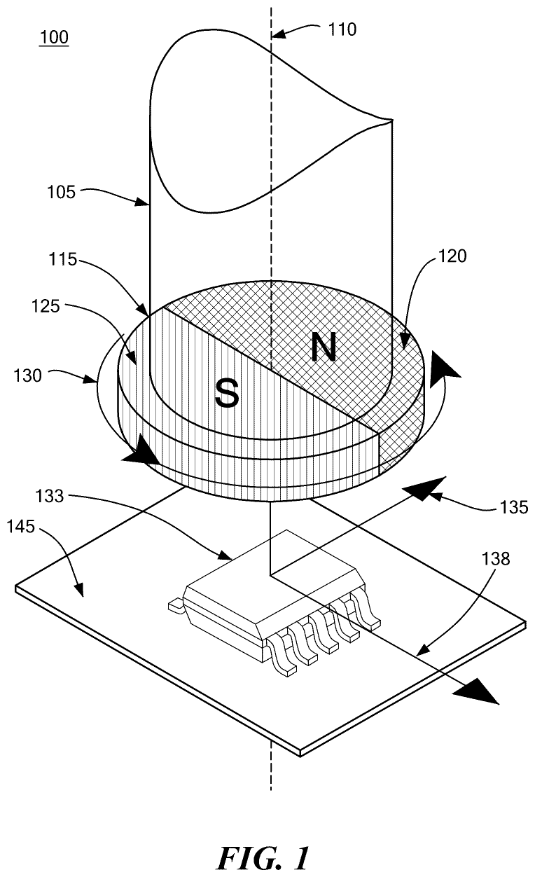

FIG. 1 shows an example system 100 that may be used to measure a rotation angle of a rotation object in accordance with example embodiments of the disclosure. In system 100, the rotation object comprises a shaft (e.g., shaft 105 of system 100), such as a rotor, and the rotation object is illustrated as rotating around an axis (e.g., axis 110 of system 100). The rotation object can rotate around an axis clockwise or counterclockwise, or can rotate clockwise at some times and counterclockwise at other times. In FIG. 1, arrow 130 illustrates a counterclockwise rotation of the rotation object about the axis, when viewed along the axis of rotation (e.g., axis 110 of FIG. 1). Although FIG. 1 illustrates an example system where a shaft or rotor rotates, the disclosure is not so limited. A person of ordinary skill in the art would recognize that magnetic field sensor devices may be used to detect a rotation angle of any object that rotates, not just shafts or rotors, so long as that object is magnetized or has a magnet attached to it. In some embodiments, the rotation object may rotate 360 degrees. In other embodiments, a rotation object may oscillate or rotate back and forth without making a full rotation.

In some embodiments, a rotation object (e.g., rotation object 105) may be magnetized, such that a magnetic field sensor device may sense a magnetic field generated by the rotation object. Alternatively, a magnet may be attached to a rotation object and the magnet may generate a magnetic field, allowing for detection of the magnetic field by a magnetic field sensor device. The magnet may be attached such that the magnet rotates with the rotation object. For example, FIG. 1 illustrates an example system 100 where a magnet 115 (e.g., disc magnet, ring magnet) has been positioned near an end (e.g., bottom) of rotation object 105. However, the disclosure is not so limited. As one alternative example, a magnet may be positioned near another end (e.g., top) of rotation object 105. In some embodiments, the magnet may be physically attached to a top or bottom of the rotation object.

In example system 100 of FIG. 1, magnet 115 is shown as being a diametrically magnetized disc magnet with a north pole 120 and a south pole 125. However, the disclosure is not limited to this example. A person of ordinary skill in the art would recognize that any form factor of magnet may be used, including, for example, disc magnets, ring magnets, bar magnets, horseshoe magnets, cylinder magnets, or any other form factor of a magnet.

A person of ordinary skill in the art would also recognize that a magnet (e.g., magnet 115 of FIG. 1) may be a permanent magnet that stays magnetized once magnetized, a temporary magnet that behaves like a magnet only when near a magnetic field, an electromagnet that behaves like a magnet only when electricity is applied, or any other type of magnet. A person of ordinary skill in the art would recognize that a magnet (e.g., magnet 115 of FIG. 1) may be made of any type of magnetic material, such as neodymium (e.g., neodymium-iron-boron (NdFeB)), samarium cobalt (e.g., SmCo), alnico (e.g., aluminum, nickel, cobalt), ceramic or ferrite (e.g., strontium carbonate, iron oxide), or any other type of magnetic material. Although magnet 115 in FIG. 1 is illustrated as being diametrically magnetized, the disclosure is not so limited. A magnet (e.g., magnet 115 of FIG. 1) used in a system (e.g., system 100 of FIG. 1) may, for example, instead be axially magnetized. And although magnet 115 in FIG. 1 shows one north pole 120 and one south pole 125, the disclosure is not so limited. A person of ordinary skill in the art would recognize that a magnet (e.g., magnet 115 of FIG. 1) may have any number of north and south poles.

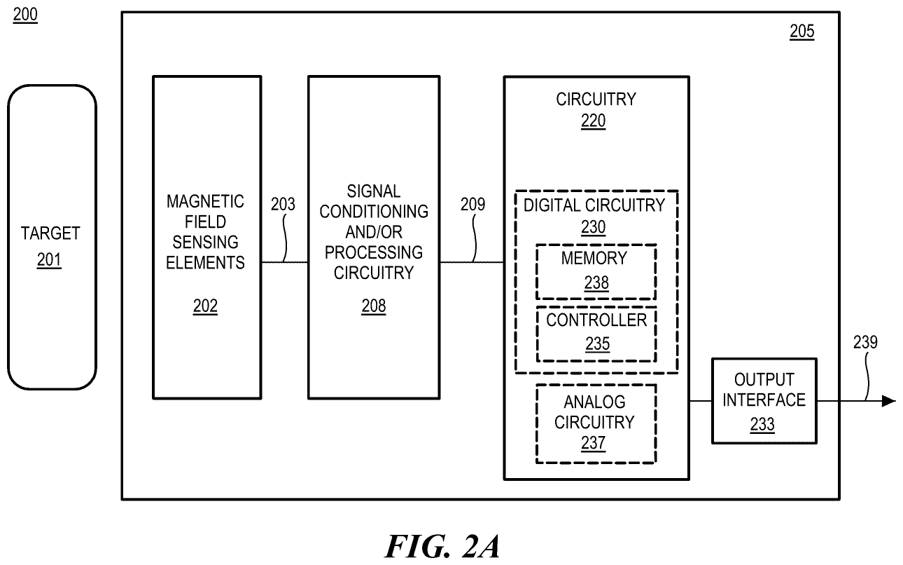

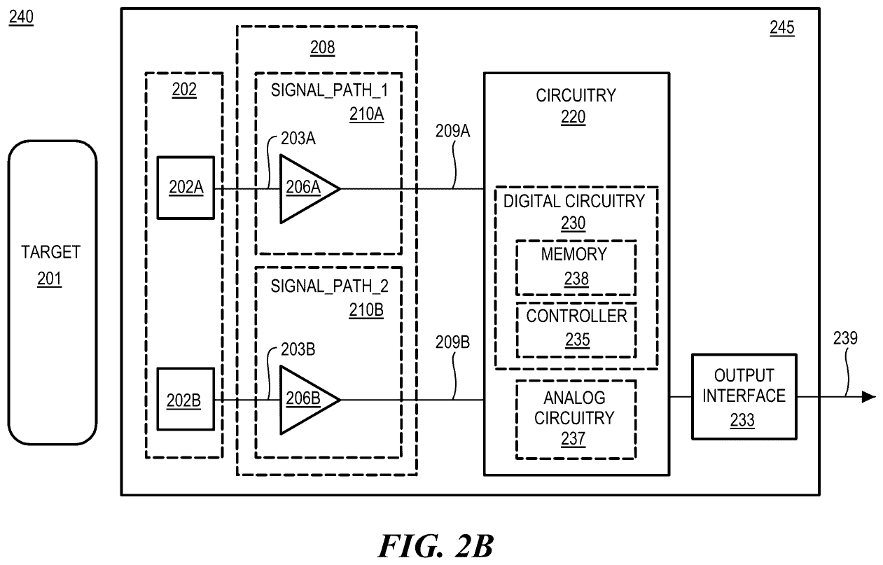

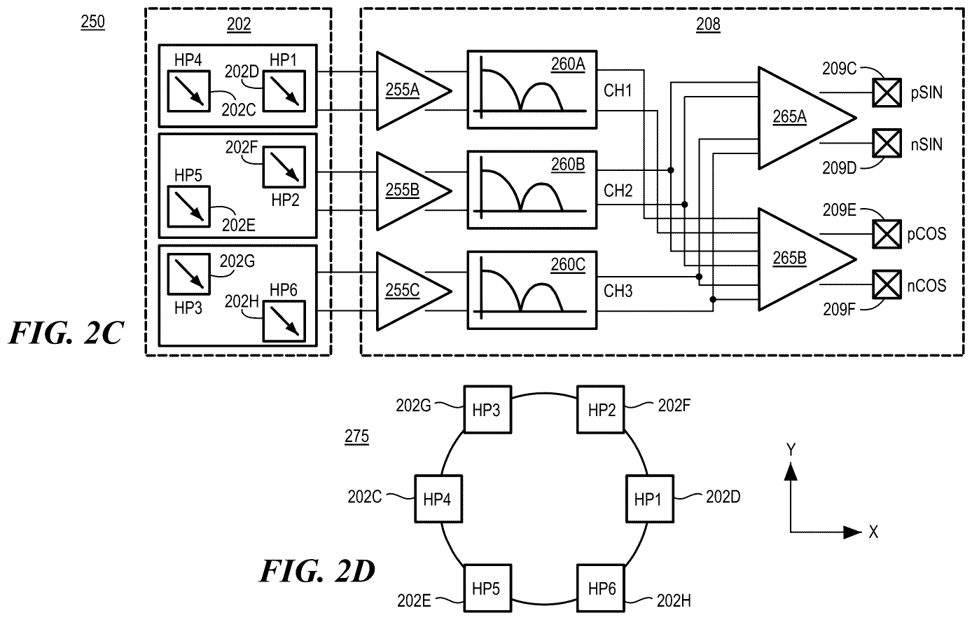

One or more magnetic field sensing elements (see, e.g., magnetic field sensing elements 202 of FIGS. 2A-2D) for sensing a magnetic field of a magnet may be positioned near the magnet. In example system 100 of FIG. 1, for example, a sensor device in a package 133 (e.g., integrated circuit) including one or more magnetic field sensing elements is positioned near magnet 115. System 100 of FIG. 1 is an example of an on-axis (e.g., end-of-shaft) arrangement, in that the one or more magnetic field sensing elements in package 133 are aligned along the rotation axis (e.g., axis 110) of the target (e.g., magnet 115). Package 133 may be positioned near magnet 115 by package 133 being positioned on or mounted to a surface 145, such as a printed circuit board (PCB) or other surface, near magnet 115.

In addition to including one or more magnetic field sensing elements, a package (e.g., package 133 of FIG. 1) may also include additional circuitry (see, e.g., FIGS. 2A-2C) for conditioning and/or processing signals representing the magnetic field generated by the one or more magnetic field sensing elements. Although FIG. 1 illustrates the one or more magnetic field sensing elements and additional circuitry as being included in a package, the disclosure is not so limited. A person of ordinary skill in the art would recognize, for example, that the one or more magnetic field sensing elements and any additional circuitry may be mounted as separate components on a PCB, for example. Alternatively, some components may be included in a package, while other components may be external to the package.

In some embodiments, the one or more magnetic field sensing elements may include at least two magnetic field sensing elements, positioned orthogonally to each other, each sensitive to an axis of a magnetic field. For example, if system 100 of FIG. 1 were mapped to X, Y, and Z axes in a Cartesian coordinate system, axis 135 may be thought of as an X axis, axis 138 may be thought of as a Y axis, and axis 110 may be thought of as a Z axis. In some embodiments, two magnetic field sensing elements may be used to measure magnetic field strength, with one of the magnetic field sensing elements having maximum sensitivity to the magnetic field along one of the X and Y axes, and the other magnetic field sensing element having maximum sensitivity to the magnetic field along the other of the X and Y axes. For example, FIG. 1 illustrates that one magnetic field sensing element in package 133 may have maximum sensitivity to a magnetic field along one axis 135 (e.g., X axis) and that another magnetic field sensing element in package 133 may have maximum sensitivity to the magnetic field along an axis 138 (e.g., Y axis) that is orthogonal to axis 135. The output of the magnetic field sensing elements may be processed and/or conditioned and sent to one or more controllers of the integrated circuit. The processed signals received by the controller(s) may be referred to as channels, with one channel corresponding to the processed and/or conditioned signal output from one of the magnetic field sensing elements, and the other channel corresponding to the processed and/or conditioned signal output from another of the magnetic field sensing elements.

In some embodiments, the one or more magnetic field sensing elements may include magnetic field sensing elements arranged about a center (see, e.g., FIG. 2D). Each of the magnetic field sensing elements may be used to measure magnetic field strength. The output of the magnetic field sensing elements may be processed and/or conditioned and sent to one or more controllers of the integrated circuit. The processed signals received by the controller(s) may be referred to as channels, with one channel corresponding to the processed and/or conditioned signal output from one or more of the magnetic field sensing elements, and one or more other channels corresponding to the processed and/or conditioned signal output from one or more others of the magnetic field sensing elements.

In response to the magnetic field generated by the target (e.g., magnet 115), the magnetic field sensing elements may each output a voltage that is proportional to the magnitude of the magnetic field as sensed by the sensor device. The output voltage may vary as the target rotates due to changes in the magnetic field of the target detected by the magnetic field sensing elements. When the magnetic field is sensed over a rotation of 360 degrees, the voltage output from one of the magnetic field sensing elements may appear as a sine curve over the 360 degrees and the voltage output from the other of the magnetic field sensing elements may appear as a cosine curve over the 360 degrees. In some embodiments, the voltages output from multiple magnetic field sensing elements may be conditioned and/or processed to result in a signal resembling a sine curve over 360 degrees of rotation of the target, and the voltages output from multiple magnetic field sensing elements may be conditioned and/or processed to result in a signal resembling a cosine curve over 360 degrees of rotation of the target. In the example shown in FIG. 1, there is only one pole pair for an entire 360 degree rotation of the rotation object, so a period of the sine curve and cosine curve may correspond to a complete 360 degree rotation of the rotation object. However, as discussed above, the disclosure is not so limited and a target may have multiple pole pairs, in which case a rotation of the target that causes one pole pair to pass by a sensor device may correspond to a measured 360 degrees of rotation of the target, and a period of the sine curve and a period of the cosine curve may correspond to a rotation of the target that causes one pole pair to pass by a sensor device.

An inverse tangent function (i.e., arctan function) may be applied to the sine and cosine curves at any given time to calculate an angle of rotation of the target at that time. For example, the two-argument arctangent function a tan 2, commonly used in computing and mathematics, may be used to calculate a rotation angle of the target based on the voltages of the sine and cosine curve at a given time. Various other techniques may be used to determine a measured rotation angle of the target instead of using an inverse tangent function, such as by using a lookup table, a polynomial fit, or a coordinate rotation digital computer (CORDIC) calculation. The calculations and/or processing required to determine the measured angle may be carried out by one or more controllers in the sensor device. That is, one or more controllers inside the package may receive sine curve and cosine curve signals and may determine a measured angle of rotation of the target based on the signals using an inverse tangent function, lookup table, polynomial fit, or CORDIC calculation.

In a sensor device utilizing a CORDIC calculation, the sensor device may also calculate a value representative of magnitude of the magnetic field as sensed by the sensor device, also referred to as a “modulus” herein. This modulus value may be utilized for various features of the sensor device, such as to adjust parameters of components in the sensor device to achieve a desired modulus value, or for error checking.

Design of an angle measurement system may depend on the needs of a particular application. Factors such as configuration, desired air gap, desired accuracy, and anticipated temperature range, among other factors, may be taken into account in designing such a system. When a sensor device is installed in proximity to a target in a system, a calibration may be performed to adjust for factors such as amplitude/gain mismatch between channels in the sensor device, offset errors where sensor device measurements may be offset from some ideal value, or misplacement of the sensor device.

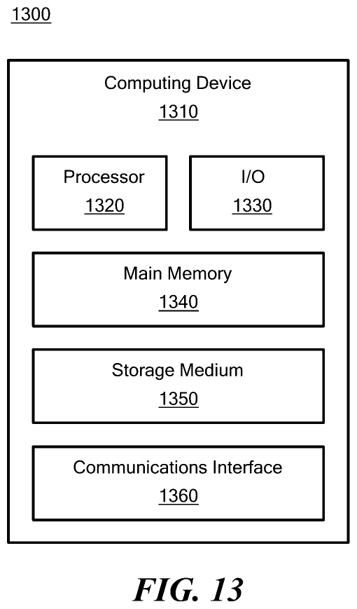

In some embodiments, it may be desired to provide a sensor device that is less costly, smaller in size, faster in processing speed, and/or more power efficient. For example, rather than utilize a sensor device that may require a digital processor, such as a CORDIC processor, it may be desired to utilize a sensor device that includes analog and/or digital circuitry that takes up less area, allowing for a smaller IC package, or a sensor device that is faster in processing speed, less costly, and/or more power efficient. One approach to providing such a sensor device may be to output the sine and cosine curve signals from the sensor device, and to calculate the rotation angle of the rotation object off the sensor device in a separate external system (e.g., computing system(s) 1230 of FIG. 12, computing device(s) 1310 of FIG. 13) that receives the signals, rather than performing these calculations within the sensor device. Nevertheless, in such a sensor device, it may still be desirable to obtain a value representative of the magnitude of the magnetic field as sensed by the sensor device. For example, such a value may be used to determine whether error conditions occur in the system. Such a value may also be output and used by an external system (e.g., computing system(s) 1230 of FIG. 12, computing device(s) 1310 of FIG. 13) to speed up a calibration time of the sensor device. Such a value may also be used by the sensor device, or by the external system, to affect gain control in the sensor device. For example, the sensor device may automatically adjust the gain of components, such as amplifiers, in the sensor device to achieve a sensed signal amplitude of a desired value or within a desired range. In some embodiments, an external system receiving the value may send feedback to the sensor device to automatically adjust the gain of the components in the sensor device. Alternatively, a user of the external system may provide a signal to the sensor device to adjust the gain of the components based on the value received by the external system.

Disclosed are example systems and methods for obtaining a representation of magnitude of a magnetic field as sensed by a sensor device. In particular, described are example systems and methods for obtaining a squared modulus value representative of magnitude of a magnetic field as sensed by a sensor device. In some embodiments, amplitudes of signals representing a magnetic field generated by a target may be sampled by the sensor device, and pulse width modulated (PWM) signals representative of the amplitudes may be generated. A double integration of a constant value over the widths of the PWM signals may then be performed, and the results of the double integrations added to obtain the squared modulus value. The squared modulus value may be representative of a magnitude of the magnetic field as sensed by the sensor device. In some embodiments, the squared modulus value may be used for controlling the gain of one or more signal paths in the sensor device. In some embodiments, the squared modulus value may be output from the sensor device for use by another system. In some embodiments, the squared modulus value may be used to determine whether an error condition has occurred in sensing the magnetic field. The systems and methods disclosed herein may be used to provide an approach to obtaining a value representative of a magnitude of a magnetic field as sensed by a sensor device, which may be more power efficient, require less space for components, be less costly, and/or be faster in processing speed than alternative approaches.

FIGS. 2A and 2B are block diagrams of example systems 200, 240, respectively, consistent with embodiments of the present disclosure, wherein like reference numbers indicate like elements. For example, system 200 of FIG. 2A may include a sensor device 205 and a rotating target 201. As previously discussed, rotating target 201 may be a magnet attached to a rotating object that may rotate with the rotating object, or alternatively may be a rotating object that is itself magnetized. Sensor device 205 may be a magnetic field sensor device configured to sense the magnetic field of rotating target 201. Sensor device 205 may use the magnetic field as sensed by the sensor device to obtain sine and cosine curves. Sensor device 205 may also use the magnetic field as sensed by the sensor device to obtain a value representative of a magnitude of the magnetic field as sensed by the sensor device. In some embodiments, sensor device 205 may also use the obtained sine and cosine curves to determine a rotation angle of the rotating object. In other embodiments, the sine and cosine curves may be output from sensor device 205 to a different external system, which may determine the rotation angle of the rotating object.

Although 200 is referred to above as a system, and 205 is referred to above as a sensor device, it should be appreciated that sensor device 205 is itself also a system, and may be referred to as such herein.

Sensor device 205 may include magnetic field sensing elements 202. As discussed above, the magnetic field sensing elements may be positioned orthogonal to each other, so as to have maximum sensitivity to orthogonal aspects of a magnetic field. Alternatively, as discussed above, the magnetic field sensing elements may be arranged around a center (see, e.g., FIG. 2D).

A magnetic field sensing element may be any type of element sensitive to a magnetic field. For example, a magnetic field sensing element may be a Hall-effect element, a magnetoresistance element, or a magnetotransistor element. For example, a magnetic field sensing element may be a Hall-effect element such as a planar Hall element, a vertical Hall element, or a circular vertical Hall (CVH) element. A magnetic field sensing element may instead be a magnetoresistance element, such as an Indium Antimonide (InSb) element, a giant magnetoresistance (GMR) element (e.g., a spin valve element), an anisotropic magnetoresistance (AMR) element, a tunneling magnetoresistance (TMR) element, or a magnetic tunnel junction (MTJ) element. A magnetic field sensing element may be a receiving coil field sensing element. A magnetic field sensing element may be a single element, or alternatively may include two or more magnetic field sensing elements arranged in one of various configurations, such as a half bridge or full (Wheatstone) bridge. Depending on the type of sensor device and application requirements, a magnetic field sensing element may be a device made of a type IV semiconductor material such as Silicon (Si) or Germanium (Ge), or of a type III-V semiconductor material such as Gallium-Arsenide (GaAs) or an Indium compound such as Indium-Antimonide (InSb). In some embodiments, multiple magnetic field sensing elements in a sensor device may be of the same type of magnetic field sensing element. In some embodiments, there may be different types of magnetic field sensing elements that work together in a sensor device.

As is known, some of the above-described magnetic field sensing elements tend to have an axis of maximum sensitivity parallel to a substrate that supports the magnetic field sensing element, and others of the above-described magnetic field sensing elements tend to have an axis of maximum sensitivity perpendicular to a substrate that supports the magnetic field sensing element. In particular, planar Hall elements tend to have axes of maximum sensitivity perpendicular to a substrate, while metal based or metallic magnetoresistance elements (e.g., GMR, TMR, AMR, spin-valve) and vertical Hall elements tend to have axes of maximum sensitivity parallel to a substrate.

The magnetic field sensing elements of sensor device 205 may output signals 203, such as voltages, that are proportional to the magnetic field strength of the magnetic field generated by the target. In some embodiments, magnetic field sensing elements may be differentially paired. For example, magnetic field sensing elements may be grouped in pairs, such that a difference between outputs of each of the pairs may be determined and output as a differential signal corresponding to the respective pair. Use of differentially-coupled magnetic field sensing elements in a sensor device may allow the sensor device to be immune to stray magnetic fields. For example, any magnetic field strength attributable to the environment, and not to the rotating target, may be sensed by each of the two magnetic field sensing elements in a differentially coupled pair. Because a magnetic field strength attributable to the environment will be approximately equally sensed at the two differentially paired magnetic field sensing elements (given their close proximity), any magnetic field strength measured by magnetic field sensing elements that is attributable to the environment will largely cancel out when a difference is taken between the measurements of the two differentially paired magnetic field sensing elements. That is, common-mode magnetic fields (i.e., common magnetic field strengths sensed by both magnetic field sensing elements in a differential pair) may be canceled out through use of differentially-paired magnetic field sensing elements.

Signals 203 provided by the magnetic field sensing elements may be conditioned and/or processed in circuitry 208. For example, the signals 203 produced by magnetic field sensing elements 202 in response to the magnetic field generated by a target may be relatively small. Accordingly, amplifiers, filters, and/or other circuits and other known techniques may be used to amplify and/or shape signals 203. In some embodiments, signals 203 may be processed and/or conditioned along channels, or signal paths, within circuitry 208. Circuitry 208 may include, for example, one or more amplifiers, analog-to-digital converters (ADCs), resistors, diodes, transistors, capacitors, inductors, and/or any other type of circuit component.

Once conditioned and/or processed in circuitry 208, the signals may be output as one or more signals 209 to circuitry 220. Circuitry 220 may include digital circuitry (e.g., digital circuitry 230), analog circuitry (e.g., analog circuitry 237), and/or a combination of digital and analog circuitry.

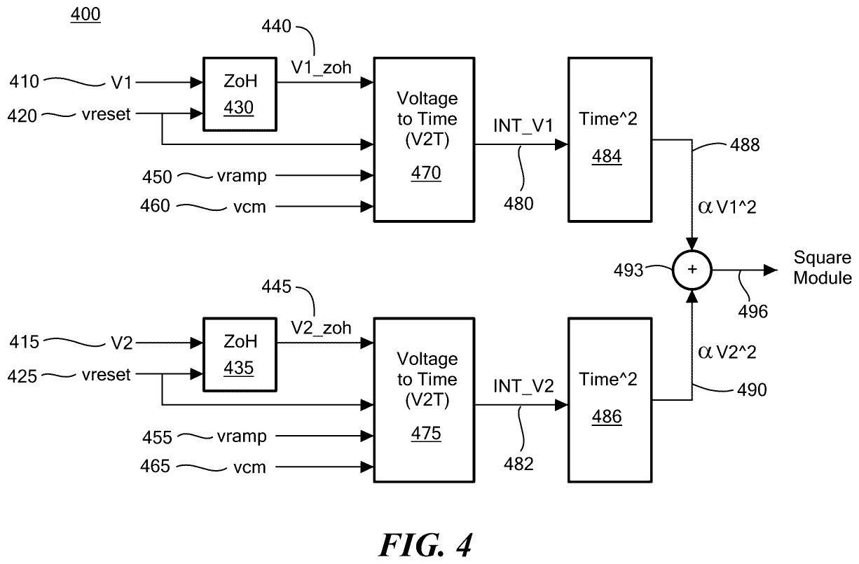

Analog circuitry (e.g., analog circuitry 237) may include, for example, circuitry described below with respect to FIGS. 4, 5, and 7. In some embodiments, the analog circuitry may be implemented as an application-specific integrated circuit (ASIC) within the sensor device. In other embodiments, the analog circuitry may be implemented as discrete components within the sensor device.

Digital circuitry (e.g., digital circuitry 230) may include one or more controllers 235. A controller may include any suitable type of processing circuitry, such as a digital ASIC, a field programmable gate array (FPGA), a CORDIC processor, a special-purpose processor, synchronous digital logic, asynchronous digital logic, a general-purpose processor (e.g., microprocessor without interlocked pipelined stages (MIPS) processor, x86 processor), etc. The one or more controllers may also include a clock. The clock may timestamp when signals received from magnetic field sensing elements or other components in the sensor device are recorded (e.g., timestamp with an elapsed amount of time measured by the clock), such that, for example, determined signal values and the times at which the signal values were received may be stored in a memory (e.g., 238). One of skill in the art would recognize that the clock need not be internal to the one or more controllers, and may instead by an external component connected to the one or more controllers.

Digital circuitry may also include one or more memories 238. A memory 238 may include any suitable type of volatile and/or non-volatile memory. In some embodiments, a memory may be a non-transitory computer readable medium. By way of example, a memory 238 may include a random-access memory (RAM), a dynamic random-access memory (DRAM), an electrically-erasable programmable read-only memory (EEPROM), and/or any other suitable type of memory. The memory may store instructions that, when executed by controller(s) 235, cause controller(s) 235 to carry out certain determinations, steps, processes, and/or calculations. For example, a memory may store instructions that, when executed by the controller, cause the controller to (1) obtain a value representative of a magnitude of a magnetic field as sensed by the sensor device, (2) determine a rotation angle of the rotation object, (3) determine whether an error condition has occurred, (4) determine whether a gain of one or more components of the sensor device should be adjusted, (5) cause a gain adjustment signal to be sent to one or more components of the sensor device, and/or (6) cause one or more signals including the value representative of the magnitude, determined rotation angle, determined error condition, or any other information to be output from the sensor device.

Sensor device 205 may include one or more voltage regulators (not shown). Voltage regulator(s) may, for example, convert or regulate voltage to provide a stable power supply to circuitry 220, circuitry 208, magnetic field sensing elements 202, output interface 233, and/or any other circuitry in sensor device 205.

Sensor device 205 may also include one or more output interfaces 233. An output interface 233 may include any suitable type of interface for outputting one or more signals (e.g., output signal(s) 239). Output interface(s) 233 may include one or more of a wired or wireless interface. By way of example, output interface(s) 233 may include a current modulator for sending information along a conductor via current pulses, a voltage modulator for sending information along a conductor via voltage pulses, an Inter-Integrated Circuit (I²C) interface, Controller Area Network (CAN) bus interface, a WiFi interface, an Ethernet interface, a Universal Serial Bus (USB) interface, a local area network (LAN) interface, a cellular (e.g., 5G) interface, and/or any other suitable type of interface. In some embodiments, output interface(s) 233 may output analog signals (e.g., analog sine and cosine curve signals).

FIG. 2B is a block diagram of another example system 240, consistent with embodiments of the present disclosure. Example system 240 may be the same as example system 200, though the disclosure is not so limited. Example system 240 includes a sensor device 245 and rotating target 201. Like sensor device 205, sensor device 245 may be a magnetic field sensor device configured to sense the magnetic field of rotating target 201. Sensor device 245 may use the magnetic field as sensed by the sensor device to obtain sine and cosine curves. Sensor device 245 may also use the magnetic field as sensed by the sensor device to obtain a value representative of a magnitude of the magnetic field as sensed by the sensor device. In some embodiments, sensor device 245 may also use the obtained sine and cosine curves to determine a rotation angle of the rotating object. In other embodiments, the sine and cosine curves may be output from sensor device 245 to a different external system, which may determine the rotation angle of the rotation object.

Although 240 is referred to above as a system, and 245 is referred to above as a sensor device, it should be appreciated that sensor device 245 is itself also a system, and may be referred to as such herein.

As with sensor device 205, sensor device 245 may include magnetic field sensing elements 202. FIG. 2B illustrates sensor device 245 as having two magnetic field sensing elements, magnetic field sensing element 202A and magnetic field sensing element 202B. As discussed above, the magnetic field sensing elements may be positioned orthogonal to each other, so as to have maximum sensitivity to orthogonal components of a magnetic field. As also discussed above, sensor device 245 may also include one or more additional magnetic field sensing elements that are differentially coupled to magnetic field sensing element 202A and/or magnetic field sensing element 202B. As discussed above with respect to sensor device 205, magnetic field sensing element 202A and magnetic field sensing element 202B may be any of a variety of different types of magnetic field sensing elements, and may be of the same type or of different types.

As with sensor device 205, sensor device 245 may output signals (e.g., signals 203A, 203B) from the magnetic field sensing elements (e.g., magnetic field sensing element 202A, magnetic field sensing element 202B) to circuitry 208. As previously discussed, circuitry 208 may condition and/or process the signals. For example, the signals (e.g., signals 203A, 203B) may be conditioned and/or processed along channels, or signal paths, within circuitry 208. FIG. 2B illustrates two separate signal paths, signal path 1 (or channel A) 210A and signal path 2 (or channel B) 210B. As previously discussed with respect to sensor device 205, circuitry 208 may include any combination of one or more of a variety of different types of components. For example, FIG. 2B illustrates circuitry 208 as including an amplifier 206A in channel A, and an amplifier 206B in channel B.

Once conditioned and/or processed in circuitry 208, signals (e.g., signals 209A, 209B) may be output to circuitry 220. Example components and operations of circuitry 208 were previously described with respect to sensor device 205. Circuitry 220 may output information through output interface 233 as one or more signals 239. Example types of information and output interfaces were previously described with respect to sensor device 205.

FIG. 2C is a block diagram 250 showing other example magnetic field sensing elements 202 and circuitry 208 that may be used in a sensor device. For example, as previously discussed, in some embodiments magnetic field sensing elements may be arranged around a center, as shown in FIG. 2D. The examples shown in FIGS. 2C and 2D illustrate six Hall plate magnetic field sensing elements being used in a sensor device, magnetic field sensing elements 202C, 202D, 202E, 202F, 202G, and 202H. In the example shown in FIG. 2C, magnetic field sensing element 202C (Hall plate 4 (HP4)) and magnetic field sensing element 202D (Hall plate 1 (HP1)) are differentially coupled, magnetic field sensing element 202E (HP5) and magnetic field sensing element 202F (HP2) are differentially coupled, and magnetic field sensing element 202G (HP3) and magnetic field sensing element 202H (HP6) are differentially coupled.

A signal output from magnetic field sensing element 202C (HP4) and a signal output from magnetic field sensing element 202D (HP1) may be received by an amplifier 255A in circuitry 208, which may amplify the signals. Similarly, a signal output from magnetic field sensing 202E (HP5) and a signal output from magnetic field sensing element 202F (HP2) may be received and amplified by an amplifier 255B. And a signal output from magnetic field sensing element 202G (HP3) and a signal output from magnetic field sensing element 202H (HP6) may be received and amplified by an amplifier 255C. In some embodiments, the amplified signals output from amplifier 255A may be filtered by a notch filter 260A. Likewise, the amplified signals output from amplifier 255B may be filtered by a notch filter 260B, and the amplified signals output from amplifier 255C may be filtered by a notch filter 260C.

Signals output from notch filters 260A, 260B, 260C may be received at one or more additional components that combine the signals in such a way as to obtain sine and cosine curves. In the example shown in FIG. 2C, these additional components are an amplifier 265A (which obtains a sine curve) and an amplifier 265B (which obtains a cosine curve). In the example shown in FIG. 2C, the differential signals are passed through circuitry 208, such that amplifier 265A outputs a positive sine curve signal 209C and a negative sine curve signal 209D, and such that amplifier 265B outputs a positive cosine curve signal 209E and a negative cosine curve signal 209F. However one of skill in the art would recognize that a difference between the signals may instead be determined within circuitry 208, such as with a differential amplifier, yielding only one output sine signal and one output cosine signal (e.g., single-ended signals). The sine and cosine curve signal outputs may be output to circuitry 220. As will be further discussed below, circuitry 220 may process the sine and cosine curve signals to obtain a value representative of a magnitude of the magnetic field as sensed by the sensor device. The sine and cosine curve signals may also be output from the sensor device, such that an external system (e.g., computing system(s) 1230 of FIG. 12, computing device(s) 1310 of FIG. 13) may determine a rotation angle of the target based on the signals. Alternatively, in some embodiments, circuitry 220 may determine a rotation angle of the target based on the sine and cosine curve signals.

FIG. 2D shows an example arrangement of magnetic field sensing elements (e.g., Hall plates) corresponding to magnetic field sensing elements 202 of FIG. 2C. In some embodiments, the magnetic field sensing elements may be arranged at equidistant intervals around a circumference of a circle. However, the disclosure is not so limited. The magnetic field sensing elements may be arranged in a semi-circle or another geometric or non-geometric pattern, if desired. Although the example shown in FIG. 2D includes six magnetic field sensing elements, the disclosure is not so limited. Any number of two or more magnetic field sensing elements arranged around a center may be used.

With magnetic field sensing elements arranged around a center, values of the sine curve may be determined as:

$$sin e curve value = {\sum }_{i = 1}^{n} {H}_{i} * {Y}_{E i} \qquad Equation 1$$

where n is the number of magnetic field sensing elements, Hᵢ is the magnetic field strength detected by a magnetic field sensing element i, and Y_{Ei} is the coordinate of magnetic field sensing element i in a Y-axis direction.
Values of the cosine curve may be determined as

$$cos ine curve value = {\sum }_{i = 1}^{n} {H}_{i} * {X}_{E i} \qquad Equation 2$$

where n is the number of magnetic field sensing elements, Hᵢ is the magnetic field strength detected by a magnetic field sensing element i, and X_{Ei} is the coordinate of magnetic field sensing element i in an X-axis direction.

In the specific example of FIGS. 2C and 2D, three channels may be provided based on six Hall plate magnetic field sensing elements spaced at equidistant intervals around a circumference of a circle. Knowing that the magnetic field sensing elements are positioned equidistant around the circumference of a circle, Equation 1 may be equivalent to:

$$sine curve value = \frac{\sqrt{3}}{2} * ( {CH}_{2} + {CH}_{3} ) \qquad Equation 3$$

and Equation 2 may be equivalent to:

$$cosine curve value = {CH}_{1} + \frac{1}{2} * ( {CH}_{2} + {CH}_{3} ) \qquad Equation 4$$

As shown in FIG. 2C, channel 2 and channel 3 may be input to amplifier 265A. Amplifier 265A may be configured to obtain the sine curve value by summing the inputs and amplifying the inputs by

$$\frac{\sqrt{3}}{2} .$$

As also shown in FIG. 2C, channel 1, channel 2, and channel 3 may be input to amplifier 265B. Amplifier 265B may be configured to obtain the cosine curve value by taking a difference between the channel 2 and channel 3 inputs, amplifying the difference by 2, and summing the amplified difference with the channel 1 input.

As previously discussed, a full period of the sine curve and cosine curve may be output when a pole pair of a target has passed the sensor device. In the case of target 115 of FIG. 1, there is only one pole pair, so a full period of the sine curve and cosine curve would correspond to 360 degrees of rotation of target 115.

As shown in FIG. 2C, the differentially coupled magnetic field sensing element signals may be passed through circuitry 208, such that the sine curve output includes a positive sine curve output 209C and a negative sine curve output 209D, and such that the cosine curve output includes a positive cosine curve output 209E and a negative cosine output 209F. However, the disclosure is not so limited. As previously discussed, a difference between the differentially coupled signals may be taken, such as by using a differential amplifier, such that only a single sine curve output is provided and such that only a single cosine curve output is provided (i.e., single-ended signals).

The sine and cosine curve outputs from circuitry 208 may be input into circuitry 220. As will be further described herein, circuitry 220 may obtain a value representative of a magnitude of the magnetic field as sensed by the sensor device based on the sine and cosine curve signals. As previously discussed, the sine and cosine curve signals may also be output, via output interface 233 for example, to an external system (e.g., computing system(s) 1230 of FIG. 12, computing device(s) 1310 of FIG. 13), which may determine a rotation angle of the target based on the sine and cosine curve signals. Alternatively, as previously discussed, circuitry 220 may use the sine and cosine curve signals to determine a rotation angle of the target.

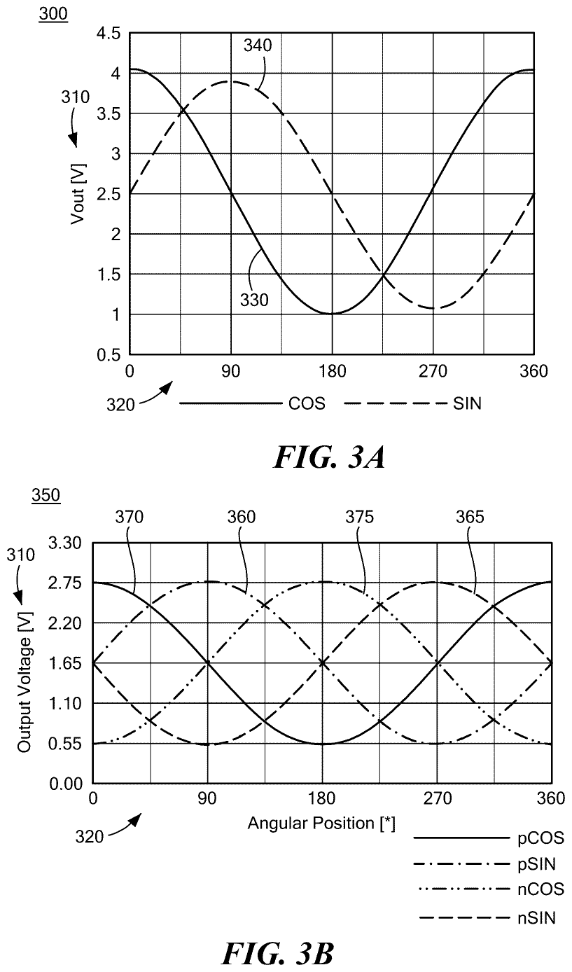

FIGS. 3A and 3B show graphs 300, 350 of example sine and cosine curve signals obtained by a sensor device. Each of these graphs has an X-axis 320 representing a rotation angle of a target in degrees, and a Y-axis 310 representing voltage in Volts (V). As shown, a period of the sine and cosine curve signals in graphs 300 and 350 corresponds to a full rotation of the target across a pole pair, which in the case of example target 115 in FIG. 1 corresponds to 360 degrees of rotation of the target.

FIG. 3A shows a sine curve signal 340 and a cosine curve signal 330. The sine curve signal and cosine curve signal are examples of sine curve and cosine curve signals that may be output when a single (e.g., single-ended) sine curve signal and a single (e.g., single-ended) cosine curve signal is output and a target is rotated 360 degrees, as previously discussed. As previously discussed, when a sensor device is installed in proximity to a target in a system, certain errors may exist, such as amplitude/gain mismatch errors between channels in the sensor device, offset errors, or errors resulting from misplacement of the sensor. As can be seen in the example of FIG. 3A, for example, the amplitudes of the sine and cosine curve signals are not the same due to some of these errors.

FIG. 3B shows a positive sine curve signal 360, a negative sine curve signal 365, a positive cosine curve signal 370, and a negative cosine curve signal 375. The sine and cosine curve signals are examples of sine curve and cosine curve signals that may be output when differential sine curve signals and cosine curve signals are output, as previously discussed. FIG. 3B depicts ideal positive sine, negative sine, positive cosine, and negative cosine curve signals (i.e., without any error).

FIG. 4 shows a block diagram of an example system 400 for obtaining a squared modulus value that is representative of a magnitude of a magnetic field as sensed by a sensor device, consistent with embodiments of the present disclosure. For example, circuitry 220 of FIG. 2A or 2B may comprise system 400. Generally speaking, circuitry 220 may convert sampled amplitudes (e.g., voltages) of the sine and cosine curve signals to time as represented by pulse-width modulated (PWM) signals of a constant amplitude. The constant amplitudes of each of these PWM signals may then be integrated twice over the time of the respective PWM signal, and the resulting values added to obtain a squared modulus value that is representative of a magnitude of the magnetic field as sensed by the sensor device.

Before further describing FIG. 4 in detail, some math is provided to demonstrate the concept mathematically. A person of ordinary skill in the art would recognize that a complex number may be represented as

$$z = x + j * y \qquad Equation 5$$

where z is the complex number, x is the real part of the complex number, y is the imaginary part of the complex number, and j is the imaginary unit.

A person of ordinary skill in the art would recognize that the same complex number may be represented instead in terms of its modulus and angle as

$$z = r * cos ( θ ) + j * r * sin θ \qquad Equation 6$$

where z is the complex number, r is the modulus, θ is the angle, which in this case is the rotation angle of the target, and j is the imaginary unit.

The complex number's modulus may be calculated as the square root of the sum of the squares of the real part and the imaginary part of the complex number, as

$$\vert z \vert = \vert \sqrt{{x}^{2} + {y}^{2}} \vert \qquad Equation 7$$

where |z| is the modulus, x² is the square of the real part of the complex number, and y² is the square of the imaginary part of the complex number.

A squared modulus may then be calculated as

$${\vert z \vert}^{2} = \vert {x}^{2} + {y}^{2} \vert \qquad Equation 8$$

where |z|² is the squared modulus. Representing x as r*cos(θ) and y as r*sin(θ) as shown in Equation 6, Equation 8 may be rewritten as

$${{\vert z \vert}^{2} = {( r * cos ( θ ) )}^{2} + ( r * sin θ ) )}^{2} \qquad Equation 9$$

When the sensor devices previously described (e.g., sensor device 205, sensor device 245) obtain sine curve and cosine curve signals, the signals represent the real and imaginary parts of a complex number. That is, the amplitude (i.e., voltage) of the cosine curve signal corresponds to the real part of the complex number (see Equations 5 and 6), and the amplitude (i.e., voltage) of the sine curve signal corresponds to the imaginary part of the complex number (see Equations 5 and 6). Thus, the squared modulus is proportional to the complex magnitude of the magnetic field as sensed by the sensor device and may be used as a value representative of the magnetic field as sensed by the sensor device.

Returning now to FIG. 4, system 400 may be used to obtain the squared modulus value based on the sine and cosine curve signals output from circuitry 208 of sensor device 205 or sensor device 245 (as shown in FIGS. 2A-2C). System 400 may have two parallel signal paths, one that processes the sine curve signal and one that processes the cosine curve signal.

For example, a sine curve signal, represented in FIG. 4 by V1 410, may be input to zero order hold (ZoH) block circuitry 430. ZoH circuitry 430 may be circuitry that holds a value of the amplitude (i.e., voltage) of V1 410 for a period of time. That is, ZoH circuitry 430 may sample an amplitude of the analog sine curve signal and hold the sampled amplitude for a period of time. That sampled amplitude may then be output as a signal 440 (represented in FIG. 4 as V1_zoh) to voltage to time (V2T) conversion circuitry 470. Voltage to time conversion circuitry 470 may also receive a voltage ramp signal 450 (represented in FIG. 4 as vramp) as an input and a common mode voltage signal 460 (represented in FIG. 4 as vcm) as an input. As will be further described herein, voltage ramp signal 450 may be compared to signal 440 in voltage to time conversion circuitry 470 to generate a digital signal pulse with a width (i.e., a pulse width modulated (PWM) signal), where a period of time of the width of the pulse is representative of the sampled amplitude of signal 410 (i.e., the amplitude of signal 440). As will also be further described herein, common mode voltage signal 460 may also be used in voltage to time conversion circuitry 470 to generate the PWM signal. The PWM signal may then be output as a signal 480 (represented in FIG. 4 as INT_V1), with the pulse width of signal 480 being proportional to the sampled amplitude (i.e., voltage) of signal 410.

Signal 480 may be received by Time\hat{ }2 circuitry 484. Time\hat{ }2 circuitry 484 may perform a double integration of the constant magnitude of signal 480 (i.e., the PWM signal) over the time of the pulse of signal 480 (i.e., the ON or logic high time of the PWM signal), giving as a result a voltage proportional to the amplitude of the sample of signal 410 squared. This voltage may be output as signal 488 (represented in FIG. 4 as α V1\hat{ }2).

The cosine curve signal may be simultaneously passed through a similar, parallel, signal processing path. For example, a cosine curve signal, represented in FIG. 4 by V2 415, may be input to ZoH block circuitry 435. ZoH circuitry may be circuitry that holds a value of the amplitude (i.e., voltage) of V2 415 for a period of time. That is, ZoH circuitry 435 may sample an amplitude of the analog cosine curve signal and hold the sampled amplitude for a period of time. In some embodiments, ZoH circuitry 435 may sample the amplitude of the analog cosine curve signal at the same, or substantially the same, time as ZoH circuitry 430 samples the amplitude of the analog sine curve signal. In some embodiments, ZoH circuitry 435 may hold the sampled value of the amplitude of the cosine curve signal for the same period of time as ZoH circuitry 430 holds the sampled value of the amplitude of the sine curve signal.

The sampled amplitude of the cosine curve signal may then be output as a signal 445 (represented in FIG. 4 as V2_zoh) to voltage to time (V2T) conversion circuitry 475. Voltage to time conversion circuitry 475 may also receive a voltage ramp signal 455 (represented in FIG. 4 as vramp) as an input and a common mode voltage signal 465 (represented in FIG. 4 as vcm) as an input. As will be further described herein, voltage ramp signal 455 may be compared to signal 445 in voltage to time conversion circuitry 475 to generate a digital signal pulse with a width (i.e., a PWM signal), where a period of time of the width of the pulse is representative of the sampled amplitude of signal 415 (i.e., the amplitude of signal 445). As will also be further described herein, common mode voltage signal 465 may also be used in voltage to time conversion circuitry 475 to generate the PWM signal. The PWM signal may then be output as a signal 482 (represented in FIG. 4 as INT_V2), with the pulse width of signal 482 being proportional to the sampled amplitude (i.e., voltage) of signal 415.

Signal 482 may be received by Time\hat{ }2 circuitry 486. Time\hat{ }2 circuitry 486 may perform a double integration of the constant magnitude of signal 482 (i.e., the PWM signal) over the time of the pulse of signal 482 (i.e., the ON or logic high time of the PWM signal), giving as a result a voltage proportional to the amplitude of the sample of signal 415 squared. This voltage may be output as signal 490 (represented in FIG. 4 as α V2\hat{ }2).

Signals 488 and 490 may be received by adding circuitry 493. Adding circuitry 493 may add the voltages of signals 488 and 490 to provide a signal 496, which is a squared modulus value, and which is therefore a value representative of the magnitude of the magnetic field as sensed by the sensor device. Adding circuitry 493 may comprise any type of known voltage adding circuitry, such as a circuit comprising one or more operational amplifiers and resistors, a switched capacitor circuit, or a current mirror based circuit, though the disclosure is not so limited.

ZoH circuitry 430 and ZoH circuitry 435 may also receive reset signals 420 (depicted in FIG. 4 as vreset) and 425 (depicted in FIG. 4 as vreset), respectively. The ZoH circuitry may be configured to sample the amplitudes of the sine and cosine curve signals at the same time (e.g., on the rising edge of the reset signals). When another reset signal is received, new samples of the sine and cosine curve signals may be obtained. Thus, system 400 may operate to obtain the squared modulus value periodically and repeatedly over time. Alternatively, the squared modulus value may be obtained on demand in response to instructions from a controller (e.g., controller 235) or from an external system (e.g., computing system(s) 1230 of FIG. 12, computing device(s) 1310 of FIG. 13). The squared modulus value may be output for use by an external system (e.g., computing system(s) 1230 of FIG. 12, computing device(s) 1310 of FIG. 13), for controlling the gain of one or more components of the sensor device (e.g., such as for use in automatically adjusting the gain of amplifiers in the sensor device), and/or for determining whether one or more error conditions have occurred.

Although FIG. 4 illustrates separate voltage ramp signals 450, 455 for the two signal processing paths, it should be appreciated that these signals may be the same signal. That is, the same voltage ramp signal may be input to voltage to time conversion circuitry 470 and to voltage to time conversion circuitry 475. Similarly, although FIG. 4 illustrates separate common mode voltage signals 460, 465 for the two signal processing paths, it should be appreciated that these signals may be the same signal. That is, the same common mode voltage signal may be input to voltage to time conversion circuitry 470 and to voltage to time conversion circuitry 475. Additionally, although FIG. 4 illustrates separate reset signals 420, 425 for the two signal processing paths, it should be appreciated that these signals may be the same signal. That is, the same reset signal may be input to voltage to time conversion circuitry 470 and to voltage to time conversion circuitry 475.

Although FIG. 4 illustrates separate ZoH circuitry, voltage to time conversion circuitry, and Time\hat{ }2 circuitry for the two signal processing paths, one of skill in the art would recognize that it may be possible to utilize one or more components within these circuitries for both signal paths, so as to reduce the number of components required to implement system 400.

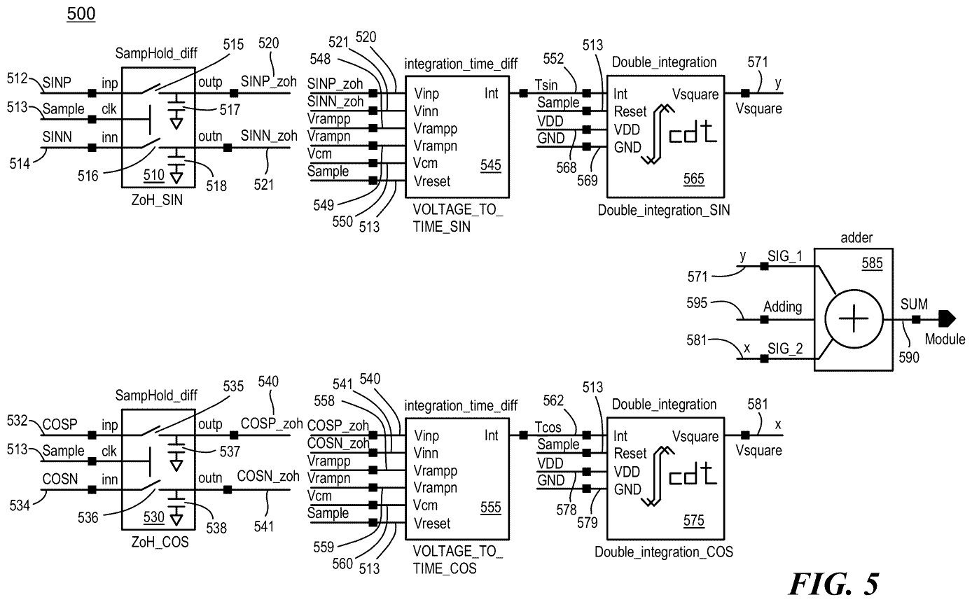

Although FIG. 4 illustrates system 400 as receiving one sine curve signal 410 (V1) and one cosine curve signal 415 (V2) (i.e., single-ended signals), system 400 may instead receive differential sine curve signals and differential cosine curve signals, as previously discussed. In such embodiments, amplitudes of each of the differential sine curve signals may be sampled and amplitudes of each of the differential cosine curve signals may be sampled, and samples of all four of these signals may be used to obtain the squared modulus value, as further discussed with respect to FIG. 5.

FIG. 5 shows a block diagram of an example system 500 for obtaining a squared modulus value that is representative of a magnitude of a magnetic field as sensed by the sensor device, consistent with embodiments of the present disclosure. System 500 may be the same as system 400, with additional details shown, though the disclosure is not so limited. System 500 may be an example of a system that receives differential sine curve signals and differential cosine curve signals, as previously discussed. As in system 400, system 500 may include two parallel signal paths, one that processes the sine curve signal(s) and one that processes the cosine curve signal(s).

For example, one or more sine curve signals may be received by zero order hold (ZoH) circuitry 510. ZoH circuitry 510 may be the same as ZoH circuitry 430, though the disclosure is not so limited. ZoH circuitry 510 may receive differentially paired sine curve signals. For example, ZoH circuitry 510 may receive a positive sine curve signal 512 at one input, and a negative sine curve signal 514 at another input. As one example of the internal circuitry of ZoH circuitry 510, ZoH circuitry 510 may include a capacitor 517, a capacitor 518, a switch 515, and a switch 516, though the disclosure is not so limited. A person of ordinary skill in the art would recognize that the switches may be implemented as one or more transistors, such as metal-oxide-semiconductor field-effect transistors (MOSFETs) or bipolar junction transistors (BJTs), as just some examples. One of skill in the art would recognize that many different ways of implementing a switch are known, any of which may be used to implement switches 515 and 516.

ZoH circuitry 515 may receive a sample signal 513 periodically, or on demand. On the rising edge of a received logic high level on sample signal 513, switches 515 and 516 may be set in an ON position, thereby charging capacitor 517 to the voltage of the amplitude of positive sine curve signal 512 and charging capacitor 518 to the voltage of the amplitude of negative sine curve signal 514. When sample signal 513 returns to a logic low value, switches 515 and 516 may be set in an OFF position, such that the voltage on capacitors 517 and 518 remains the same for a period of time. ZoH circuitry 515 may output the sampled amplitude (i.e., voltage) of the positive sine curve signal as signal 520 (represented in FIG. 5 as SINP_zoh), and may output the sampled amplitude (i.e., voltage) of the negative sine curve signal as signal 521 (represented in FIG. 5 as SINN_zoh).

Voltage-to-time conversion circuitry 545 may receive signals 520 and 521. Voltage-to-time conversion circuitry 545 may be the same as voltage to time conversion circuitry 470, though the disclosure is not so limited. Voltage-to-time conversion circuitry 545 may also receive a positive voltage ramp signal 548 (represented in FIG. 5 as Vrampp) and a negative voltage ramp signal 549 (represented in FIG. 5 as Vrampn). Positive voltage ramp signal 548 (Vrampp) may ramp from a voltage of 0V to a power supply voltage level (e.g., VCC), and negative voltage ramp signal 549 (Vrampn) may ramp from the power supply voltage level (e.g., VCC) to a voltage of 0V. Thus, a sampled sine curve value (i.e., ZoH sine curve value) from the differential signals may be equivalent to

$$ZoH sine curve value = SINP\_zoh - SINN\_zoh \qquad Equation 10$$

and a Vramp signal from the differential Vramp signals may be equivalent to

$$Vramp = Vrampp - Vrampn \qquad Equation 11$$

(i.e., Vramp ramps from a negative power supply voltage (e.g., −VCC) to a positive power supply voltage (e.g., VCC)). The differential signals 520 and 521 may then be differentially compared to the differential voltage ramp signals, such that the sampled sine curve value is compared with the Vramp signal to generate a digital signal pulse with a width (i.e., a PWM signal), where a period of time of the width of the pulse is representative of the amplitude of the sampled sine curve value. Voltage-to-time conversion circuitry 545 may also receive a common mode voltage signal 550 (represented in FIG. 5 as Vcm), which in the example of processing differential signals as discussed with reference to FIG. 5 may be a voltage of 0V. Common mode voltage signal 550 may also be used in voltage-to-time conversion circuitry 545 to generate the PWM signals, as will be further described herein.

A PWM signal may then be output as a signal 552 (represented in FIG. 5 as Tsin), with the pulse width of signal 552 being proportional to the sampled sine curve value. Voltage-to-time conversion circuitry 545 may also receive sample signal 513. Sample signal 513, when at a logic high level, may reset voltage-to-time conversion circuitry 545 so that it is ready to generate a PWM signal based on newly sampled amplitudes of positive sine curve signal 512 and negative sine curve signal 514.

Signal 552 may be received by double integration circuitry 565. Double integration circuitry 565 may be the same as Time\hat{ }2 circuitry 484, though the disclosure is not so limited. Double integration circuitry 565 may perform a double integration of the constant magnitude of signal 552 (i.e., the PWM signal) over the width of the pulse of signal 552 (i.e., the ON time or logic high time of the PWM signal), giving as a result a voltage proportional to the sampled sine curve value squared. This voltage may be output as signal 571 (represented in FIG. 5 as y). Double integration circuitry 565 may also receive a power supply voltage (represented in FIG. 5 as VDD) at a terminal 568 and a ground reference voltage at a terminal 569. Double integration circuitry 565 may also receive sample signal 513. Sample signal 513, when at a logic high level, may reset double integration circuitry 565 so that it is ready to perform a double integration of a newly generated PWM signal.

The cosine curve signal may be simultaneously passed through a similar, parallel, signal processing path. For example, one or more cosine curve signals may be received by ZoH circuitry 530. ZoH circuitry 530 may be the same as ZoH circuitry 435, though the disclosure is not so limited. ZoH circuitry 530 may receive differentially paired cosine curve signals. For example, ZoH circuitry 530 may receive a positive cosine curve signal 532 at one input, and a negative cosine curve signal 534 at another input. As one example of the internal circuitry of ZoH circuitry 530, ZoH circuitry 530 may include a capacitor 537, a capacitor 538, a switch 535, and a switch 536, though the disclosure is not so limited. A person of ordinary skill in the art would recognize that the switches may be implemented as one or more transistors, such as MOSFETs or BJTs, as just some examples. One of skill in the art would recognize that many different ways of implementing a switch are known, any of which may be used to implement switches 535 and 536.

ZoH circuitry 535 may receive sample signal 513 periodically, or on demand. On the rising edge of a received logic high value on sample signal 513, switches 535 and 536 may be set in an ON position, thereby charging capacitor 537 to the voltage of the amplitude of positive cosine curve signal 532 and charging capacitor 538 to the voltage of the amplitude of negative cosine curve signal 534. When sample signal 513 returns to a logic low value, switches 535 and 536 may be set in an OFF position, such that the voltage on capacitors 537 and 538 remains the same for a period of time. ZoH circuitry 530 may output the sampled amplitude (i.e., voltage) of the positive sine curve signal as signal 540 (represented in FIG. 5 as COSP_zoh), and may output the sampled amplitude (i.e., voltage) of the negative cosine curve signal as signal 541 (represented in FIG. 5 as COSN_zoh).

Voltage-to-time conversion circuitry 555 may receive signals 540 and 541. Voltage-to-time conversion circuitry 555 may be the same as voltage to time conversion circuitry 475, though the disclosure is not so limited. Voltage-to-time conversion circuitry 555 may also receive a positive voltage ramp signal 558 (represented in FIG. 5 as Vrampp) and a negative voltage ramp signal 559 (represented in FIG. 5 as Vrampn). Positive voltage ramp signal 558 (Vrampp) may ramp from a voltage of 0V to a power supply voltage level (e.g., VCC), and negative voltage ramp signal 559 (Vrampn) may ramp from the power supply voltage level (e.g., VCC) to a voltage of 0V. Thus, a sampled cosine curve value (i.e., ZoH cosine curve value) from the differential signals may be equivalent to

$$ZoH cosine curve value = COSP\_zoh - COSN\_zoh \qquad Equation 12$$

and a Vramp signal from the differential Vramp signals may be equivalent to

$$Vramp = Vrampp - Vrampn \qquad Equation 13$$

(i.e., Vramp ramps from a negative power supply voltage (e.g., −VCC) to a positive power supply voltage (e.g., VCC)). The differential signals 540 and 541 may then be differentially compared with the differential voltage ramp signals, such that the sampled cosine curve value is compared with the Vramp signal to generate a digital signal pulse with a width (i.e., a PWM signal), where a period of time of the width of the pulse is representative of the amplitude of the sampled cosine curve value. Voltage-to-time conversion circuitry 555 may also receive a common mode voltage signal 560 (represented in FIG. 5 as Vcm), which in the example of processing differential signals discussed with reference to FIG. 5 may be a voltage of 0V. Common mode voltage signal 560 may also be used in voltage-to-time conversion circuitry 555 to generate the PWM signals, as will be further described herein.

A PWM signal may then be output as a signal 562 (represented in FIG. 5 as Tcos), with the pulse width of signal 562 being proportional to the sampled cosine curve value. Voltage-to-time conversion circuitry 555 may also receive sample signal 513. Sample signal 513, when at a logic high level, may reset voltage-to-time conversion circuitry 555 so that it is ready to generate a PWM signal based on newly sampled amplitudes of positive cosine curve signal 532 and negative cosine curve signal 534.

Signal 562 may be received by double integration circuitry 575. Double integration circuitry 575 may be the same as Time\hat{ }2 circuitry 486, though the disclosure is not so limited. Double integration circuitry 575 may perform a double integration of the constant magnitude of signal 562 (i.e., the PWM signal) over the width of the pulse of signal 562 (i.e., the ON time or logic high time of the PWM signal), giving as a result a voltage proportional to the sampled cosine value squared. This voltage may be output as signal 581 (represented in FIG. 5 as x). Double integration circuitry 575 may also receive a power supply voltage (represented in FIG. 5 as VDD) at a terminal 578 and a ground reference voltage at a terminal 579. Double integration circuitry may also receive sample signal 513. Sample signal 513, when at a logic high level, may reset double integration circuitry 575 so that it is ready to perform a double integration of a newly generated PWM signal.

Signals 571 and 581 may be received by adding circuitry 585. Adding circuitry 585 may be the same as adding circuitry 493, though the disclosure is not so limited. Adding circuitry 585 may also receive an adding signal 595. When adding signal 595 is at a logic high level, adding circuitry 585 may add the voltages of signals 571 and 581 to provide a signal 590, which is representative of the squared modulus, and which is therefore a value representative of the magnitude of the magnetic field as sensed by the sensor device. Adding circuitry 585 may comprise any type of known voltage adding circuitry, such as a circuit comprising one or more operational amplifiers and resistors, a switched capacitor circuit, or a current mirror based circuit, though the disclosure is not so limited.

As shown in FIG. 5, sample signal 513 may be input to ZoH circuitry 510, voltage-to-time conversion circuitry 545, double integration circuitry 565, ZoH circuitry 530, voltage-to-time conversion circuitry 555, and double integration circuitry 575. That is, all these different circuitry blocks may operate using the same sample signal.

Although FIG. 5 illustrates separate positive voltage ramp signals 548, 558 for the two signal processing paths, it should be appreciated that these signals may be the same signal. That is, the same positive voltage ramp signal may be input to voltage-to-time conversion circuitry 545 and to voltage-to-time conversion circuitry 555. Similarly, although FIG. 5 illustrates separate negative voltage ramp signals 549, 559 for the two signal processing paths, it should be appreciated that these signals may be the same signal. That is, the same negative voltage ramp signal may be input to voltage-to-time conversion circuitry 545 and to voltage-to-time conversion circuitry 555. Additionally, although FIG. 5 illustrates separate common mode voltage signals 550, 560 for the two signal processing paths, it should be appreciated that these signals may be the same signal. That is, the same common mode voltage signal (e.g., 0V) may be input to voltage-to-time conversion circuitry 545 and to voltage-to-time conversion circuitry 555.

Although FIG. 5 illustrates separate power supply signals 568, 578 for the two signal processing paths, it should be appreciated that these signals may be the same signal. That is, the same VDD (or VCC) signal may be input to double integration circuitry 565 and to double integration circuitry 575. Similarly, although FIG. 5 illustrates separate ground (GND) signals 569, 579 for the two signal processing paths, it should be appreciated that these signals may be the same signal. That is, the same GND signal may be input to double integration circuitry 565 and to double integration circuitry 575.

Although FIG. 5 only illustrates power supply and ground signals being input to double integration circuitry 565 and double integration circuitry 575, one of skill in the art would recognize that ZoH circuitry 510, ZoH circuitry 530, voltage-to-time conversion circuitry 545, voltage-to-time conversion circuitry 555, and/or adding circuitry 585 may also receive power supply and ground signals, so as to power internal circuitry and/or components of these circuitry blocks.

Although FIG. 5 illustrates separate ZoH circuitry, voltage-to-time conversion circuitry, and double integration circuitry for the two signal processing paths, one of skill in the art would recognize that it may be possible to utilize one or more components within these circuitries for both signal paths, so as reduce the number of components required to implement system 500.

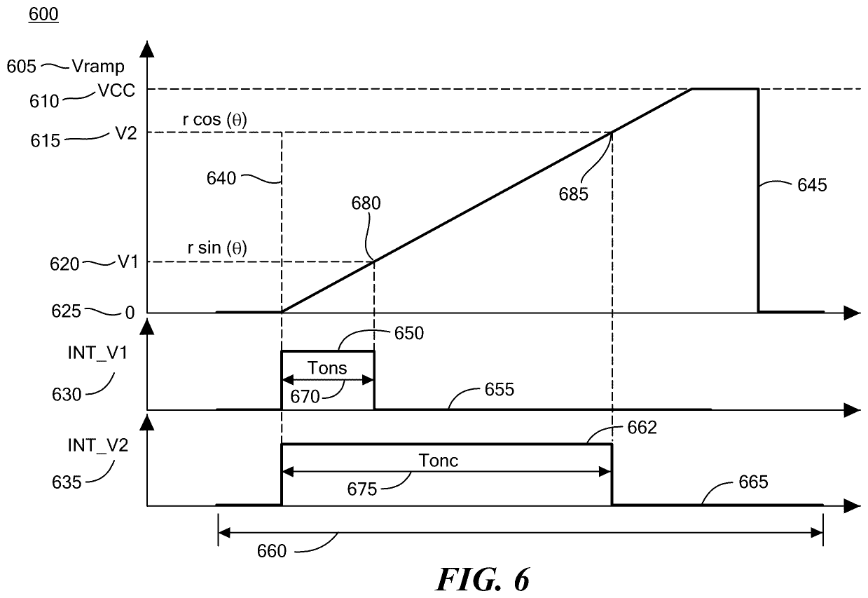

FIG. 6 shows graphs 600 demonstrating an example voltage-to-time conversion process, consistent with embodiments of the present disclosure. For example, graphs 600 illustrate how signals having a sampled amplitude from a sine and/or cosine curve signal may be converted into a PWM signal with a width (i.e., time) representative of the sampled amplitude in voltage to time conversion circuitry (e.g., in voltage to time conversion circuitries 470, 475, in voltage-to-time conversion circuitries 545, 555). The Y-axes of the graphs correspond to voltage and the X-axes 660 of the graphs correspond to time. The graphs are aligned to show how the timing between different signals aligns in the voltage to time conversion process.

Graph 605 illustrates a level of a power supply voltage to the voltage-to-time conversion circuitry with dotted line 610. Although illustrated as VCC in FIG. 6, the power supply may also be represented as VDD, as discussed above with respect to FIG. 5. As shown in FIG. 6, a voltage ramp signal 645 may ramp from a starting voltage 625 (0 Volts in the example of FIG. 6) to an ending voltage 610 (VCC in the example of FIG. 6). Voltage ramp signal 645 may then return to the starting voltage and may again ramp from the starting voltage to the ending voltage. Voltage ramp signal 645 may ramp from the starting voltage to the ending voltage periodically, such that the voltage ramp may be compared with the sampled amplitudes of the sine and/or cosine curve signals. Voltage ramp signal 645 may correspond to signals 450, 455 (vramp) of system 400. That is, voltage ramp signal 643 may correspond to a voltage ramp signal in voltage-to-time conversion circuitry where a single sine curve signal and a single cosine curve signal are sampled (i.e., single-ended signals). As discussed above with respect to FIG. 5, in embodiments where differential sine (e.g., SINP, SINN) and cosine (e.g., COSP, COSN) signals are processed, a positive voltage ramp signal (Vrampp) 548, 558 may ramp from a starting voltage of 0 Volts up to an ending power supply voltage (e.g., VCC, VDD), and a negative voltage ramp signal (Vrampn) 549, 559 may ramp from a starting power supply voltage (e.g., VCC, VDD) down to an ending voltage of 0 Volts, such that the differential equivalent is a voltage ramp that ramps from the negative power supply voltage (e.g., −VCC, −VDD) to the positive supply voltage (e.g., VCC, VDD).

V1 620 represents an example sampled amplitude of the sine curve signal (i.e., r*sin(6)), which may correspond, for example, to signal 440 (V1_zoh). V2 615 represents an example sampled amplitude of the cosine curve signal (i.e., r*cos(6)), which may correspond, for example, to signal 445 (V2_zoh). Voltage ramp signal 645 may be compared with V2 615 and V1 620, such as through use of one or more comparators. As previously discussed with respect to FIG. 5, in embodiments where differential sine (e.g., SINP, SINN) and cosine (e.g., COSP, COSN) signals are processed, the differential equivalent of the voltage ramp may be a voltage ramp that ramps from a negative power supply voltage (e.g., −VCC, −VDD) to a positive supply voltage (e.g., VCC, VDD).

As mentioned previously, the sine and cosine curve signals may be periodically sampled and the squared modulus value may be obtained periodically, so that the squared modulus value may be monitored to adjust a gain of components in the sensor device and/or to identify one or more errors in the sensor device. Thus, voltage ramp signal 645 may ramp from the starting voltage to the ending voltage periodically, and the comparison with the sampled sine curve and cosine curve signals performed periodically, such as in accordance with a clock signal. That is, the signals shown in FIG. 6 may correspond to one cycle of a repeating process where amplitudes of sine and cosine curve signals are sampled and compared with the voltage ramp. At the beginning of the cycle, a reset signal (e.g., reset signal 420 or 425) or sample signal (e.g., sample signal 513) may cause voltages of the sine and cosine curve signals to be sampled, and may reset the voltages of voltage ramp signal 645 and voltages of the PWM signals to a low value (e.g., 0 Volts). Then, after voltages of the sine and cosine curve signals have been sampled, these voltages may be compared with the voltage ramp signal.

As shown in FIG. 6, when voltage ramp signal 645 begins to ramp up at time 640, the PWM signals (e.g., signal 480, signal 482, signal 552, signal 562) may change from a logic low level (e.g., 0V) to a logic high level (constant power supply voltage (e.g., VCC, VDD)). The PWM signal may be kept at the logic high level until the voltage of voltage ramp signal 645 crosses the value of the voltage of the sampled amplitude of the respective sine or cosine curve signal. That is, as shown in graph 630 in the example in FIG. 6, when the voltage of voltage ramp signal 645 crosses the sampled voltage of the sine curve signal (V1) at time 680, the PWM signal corresponding to the sine curve signal processing path (e.g., signal 480, signal 552) may be changed from the logic high level back to the logic low level.

This is illustrated in graph 630, where signal 480 (INT_V1) changes from a logic low level 655 to a logic high level 650 at a time 640, and then changes from logic high value 650 to logic low level 655 at time 680. As shown in FIG. 6, the result is that signal 480 (INT_V1) was at a high logic level for a time 670 (Tons), which is proportional to the amplitude (i.e., voltage) of the sampled sine curve signal.

As also shown in graph 635 in the example in FIG. 6, when the voltage of voltage ramp signal 645 crosses the sampled voltage of the cosine curve signal (V2) at time 685, the PWM signal corresponding to the cosine curve signal processing path (e.g., signal 482, signal 562) may be changed from the logic high level back to the logic low level.

This is illustrated in graph 635, where signal 482 (INT_V2) changes from a logic low level 665 to a logic high level 662 at a time 640, and then changes from logic high value 662 to logic low level 665 at time 685. As shown in FIG. 6, the result is that signal 482 (INT_V2) was at a high logic level for a time 675 (Tonc), which is proportional to the amplitude (i.e., voltage) of the sampled cosine curve signal.

Although the logic low level in graph 630 is illustrated with a different reference number (655) than the logic low level in graph 635 (reference number 665), it should be appreciated that the voltages of the logic low levels in graphs 630 and 635 may be the same. Similarly, although the logic high level in graph 630 is illustrated with a different reference number (650) than the logic high level in graph 635 (reference number 662), it should be appreciated that the voltages of the logic high levels in graphs 630 and 635 may be the same.

As discussed above, FIG. 6 illustrates how sampled voltages may be converted to time, by converting the sampled voltage to a signal of constant amplitude, but where a width or time of the signal is proportional to the sampled voltage. However, the approach discussed with respect to FIG. 6 may only work when both the sine and cosine curve signals are in the positive portions of their periods (i.e., above the offset voltages around which the sine and cosine curves oscillate). Thus, another approach that also utilizes a common mode voltage will be described later herein, which may allow for a voltage to time conversion when both the sine and cosine curves are in the positive portions of their periods, when the sine curve is in the positive portion of its period and the cosine curve is in the negative portion of its period, when the sine curve is in the negative portion of its period and the cosine curve is in the positive portion of its period, and when both the sine curve and the cosine curve are in the negative portions of their periods. That is, the approach utilizing the common mode voltage may allow for voltage to time conversion regardless of which of the four quadrants a complex number representing the magnetic field falls into at a given time, allowing for a squared modulus to be obtained for all 360 degrees of rotation of a target.

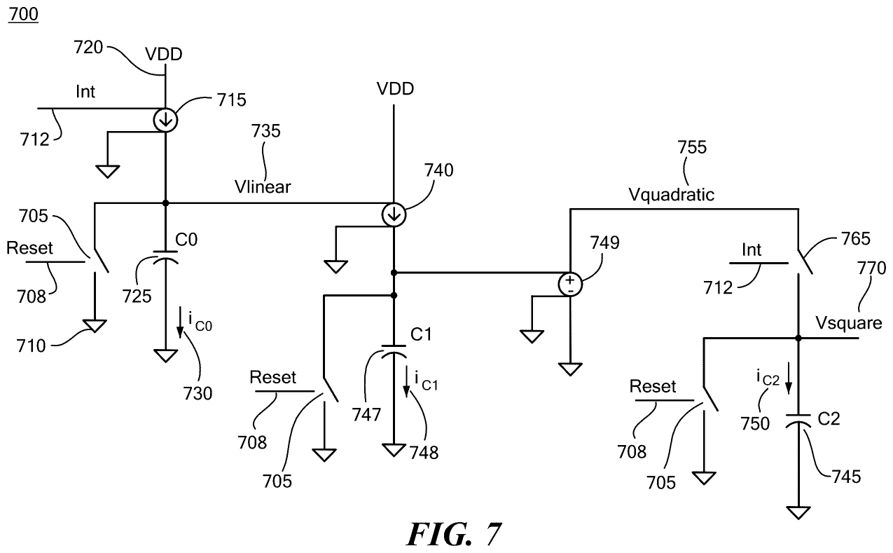

FIG. 7 shows a block diagram of an example system 700 for performing a double integration of a time derived from a voltage-to-time conversion process, consistent with embodiments of the present disclosure. For example, system 700 may correspond to Time\hat{ }2 circuitry 484 of system 400, Time\hat{ }2 circuitry 486 of system 400, double integration circuitry 565 of system 500, and/or double integration circuitry 575 of system 500. System 700 may correspond to an analog approach to implementing any of these blocks of circuitry. The circuitry in system 700 may operate to perform a double integration of the constant value of a PWM signal (e.g., signal 480, signal 482, signal 552, signal 562) over the pulse width of the PWM signal.

As shown in FIG. 7, system 700 may include a ground potential 710, a voltage terminal 720 (e.g., VDD), a current source 715 (e.g., transistor, such as MOSFET or BJT), and a capacitor 725 (represented in FIG. 7 as C₀) to which a current 730 (represented in FIG. 7 as ico) flows. Current source 715 may be controlled by an input signal 712 (represented in FIG. 7 as “Int”). Input signal 712 (Int) may the PWM signal output from one of the voltage to time conversion blocks. Current 730 may be related to the voltage of input signal 712 (Int) by a transconductance G_{M}. Current 730 may charge capacitor 725 to a voltage Vlinear 735. System 700 may also include a current source 740 (e.g., transistor, such as MOSFET or BJT) and a capacitor 747 (represented in FIG. 7 as C₁) to which a current 748 (represented in FIG. 7 as i_{C1}) flows. Current 748 may be related to voltage Vlinear 735 by a transconductance G_{M}. Current 748 may charge capacitor 747 to a voltage (V_{C1}) and that voltage may be applied to a voltage-controlled voltage source 749. Voltage-controlled voltage source 749 may output a voltage Vquadratic 755 based on the applied voltage (V_{C1}). System 700 may also include a switch 765 and a capacitor 745 (represented in FIG. 7 as C₂) to which a current 750 (represented in FIG. 7 as i_{C2}) flows. System 700 may also include switches 705. A person of ordinary skill in the art would also recognize that each of switches 705 and switch 765 may be implemented as one or more transistors, such as MOSFETs or BJTs as just some examples. One of skill in the art would recognize that many different ways of implementing a switch are known, any of which may be used to implement any of switches 705 and/or switch 765.

The PWM signal (represented in FIG. 7 as “Int”) output from one of the voltage to time conversion blocks may be used to control current source 715 and switch 765. For example, current source 715 and switch 765 may be controlled by signal 480, signal 482, signal 552, or signal 562. When the PWM signal is at a logic high level, current source 715 may be turned ON and switch 765 may be set to an ON position, such that current 730 (i_{C0}) flows to capacitor 725 (C₀), such that current 748 (i_{C1}) flows to capacitor 747 (C₁), and such that current 750 (i_{C2}) flows to capacitor 745 (C₂), and such that a voltage Vsquare 770 is output. When the PWM signal is at a logic low level, current source 715 may be turned OFF and switch 765 may be set to an OFF position. Switches 705 may be controlled by a reset signal to discharge the capacitors (e.g., capacitor C₀, capacitor C₁, capacitor C₂), such that the circuit is reset and ready to perform another double integration on another PWM signal from the voltage-to-time conversion process. For example, switches 705 may be controlled by vreset signal(s) 420, 425 or by sample signal(s) 513. That is, switches 705 may be set in an ON position when vreset signal(s) 420, 425 or sample signal(s) 513 are at a logic high (e.g., 1 or VCC) value, thereby coupling each of the capacitors (e.g., capacitor C₀, capacitor C₁, capacitor C₂) to ground such that the capacitors discharge. When vreset signal(s) 420, 425 or sample signal(s) 513 return to a logic low (e.g., 0 or 0V) value), switches 705 may be set in an OFF position, and system 700 may be ready to perform another double integration on another PWM signal from the voltage-to-time conversion process.

As shown in FIG. 7, voltage 735 (Vlinear) may then be equivalent to

$$Vlinear = \frac{1}{{C}_{0}} * {\int }_{0}^{T} {i}_{C0} ( t ) * dt \qquad Equation 14$$

where C₀ is the capacitance of capacitor C₀, i_{C0} (t) is the current 730 (i_{C0}) to capacitor 725 (C₀) over time, and Tis the period of the cycle during which the voltage ramp signal is compared to the sampled amplitude (e.g., the time of a period (or cycle) of the voltage ramp signal). Equation 14 may be equivalent to

$${Vlinear = \frac{I}{{C}_{0}} * t \vert}_{0}^{{T}_{ON}} \qquad Equation 15$$

where T_{ON} is the time of the cycle during which the PWM signal (represented in FIG. 7 as “Int”) is at a logic high level, and I is the current of current source 715 (I). Equations 14 and 15 may also be equivalent to

$$Vlinear = \frac{I * {T}_{ON}}{{C}_{0}} \qquad Equation 16$$

The circuit may be configured such that voltage 735 (Vlinear) never reaches a maximum possible value of Vlinear (Vlinearₘₐₓ) through choice of an appropriate capacitor and current source, because the time at which the voltage is at a logic high level (T_{ON}) may always be a lesser amount of time than the time of the cycle.

As shown in FIG. 7, voltage 755 (Vquadratic) may be equivalent to

$$V quadratic = \frac{1}{{C}_{2}} * {\int }_{0}^{T} {i}_{C 2} ( t ) * d t \qquad Equation l 7$$

where C₂ is the capacitance of capacitor C₂ and i_{C2} (t) is the current 750 to capacitor 745 (C₂) over time. Equation 17 may be equivalent to

$$V quadratic = \frac{I * {G}_{M}}{{C}_{2} * {C}_{0}} * {\int }_{0}^{T} t * d t \qquad Equation 18$$

where G_{M} is the transconductance of current sources 715, 740 (G_{M}). Equations 17 and 18 may be equivalent to

$${V quadratic = \frac{I * {G}_{M}}{2 * {C}_{0} * {C}_{2}} * {t}^{2} \vert}_{0}^{{T}_{ON}} \qquad Equation l9$$

Equation 19 may also be equivalent to

$$V quadratic = \frac{I * {G}_{M}}{2 * {C}_{2} * {C}_{0}} * {T}_{ON}^{2} \qquad Equation 20$$

The circuit may be configured such that voltage 755 (Vquadratic) never reaches a maximum possible value of Vquadratic (Vquadraticₚₑₐₖ) through choice of appropriate components, because the time at which the voltage is at a logic high level (T_{ON}) may always be a lesser amount of time than the time of the cycle.

System 700 may be utilized to perform the double integration in both the sine curve and cosine curve signal processing paths. For example, system 700 may be used as Time\hat{ }2 circuitry 484, as Time\hat{ }2 circuitry 486, as double integration circuitry 565, and/or as double integration circuitry 575. When a PWM signal from the sine curve processing path is input to system 700 as signal 712 (Int), the result may be

$$V s q u a r {e}_{s i n e} = \frac{a}{2} * {T}_{o n s}^{2} \qquad Equation 21$$

where Vsquareₛᵢₙₑ is Vsquare for the sine curve processing path, Tₒₙₛ is T_{ON} for the sine curve processing path, and a is

$$a = \frac{I * {G}_{M}}{2 * {C}^{2}} \qquad Equation 22$$

where C is the capacitance of each of capacitors 725 (C₀) and 745 (C₂), when they are equivalent. Similarly, when a PWM signal from the cosine curve path is input to system 700 as signal 712 (Int), the result may be

$$V s q u a r {e}_{c o s i n e} = \frac{a}{2} * {T}_{o n c}^{2} \qquad Equation 23$$

where Vsquare_{cosine} is Vsquare for the cosine curve processing path, and T_{onc} is T_{ON} for the cosine curve processing path. Then adding circuitry (e.g., adding circuitry 493, adding circuitry 585) may add the voltages Vsquareₛᵢₙₑ and Vsquare_{cosine} to get

$$V s q u a r {e}_{s i n e} + V s q u a r {e}_{c o s i n e} = \frac{a}{2} * {T}_{o n s}^{2} + \frac{a}{2} * {T}_{o n c}^{2} {α ( r * sin ( θ ) )}^{2} + {( r * cos ( θ ) )}^{2} = {r}^{2} \qquad Equation 24$$

That is, the sum of the voltages Vsquareₛᵢₙₑ and Vsquare_{cosine} are proportional to the sum of (r*sin(θ))²+(r*cos(θ))², where r is the modulus, and θ is the rotation angle of the target. The sum of (r*sin(θ))²+(r*cos(θ))² is equal to r², which is the squared modulus. That is, the sum of the voltages Vsquareₛᵢₙₑ and Vsquare_{cosine} are proportional to the squared modulus and yield a squared modulus value.

System 700 may be reset by controlling switches 705. For example, a reset signal or sample signal (e.g., signal 420, signal 425, signal 513) may be coupled to switches 705, such that when the reset signal or sample signal goes to a logic high value, switches 705 are put in an ON position and capacitors C₀, C₁, and C₂ are discharged. When the reset signal or sample signal returns to a logic low value, switches 705 may be put back into an OFF position, such that capacitors C₀, C₁, and C₂ may be charged and a voltage Vsquare sampled.

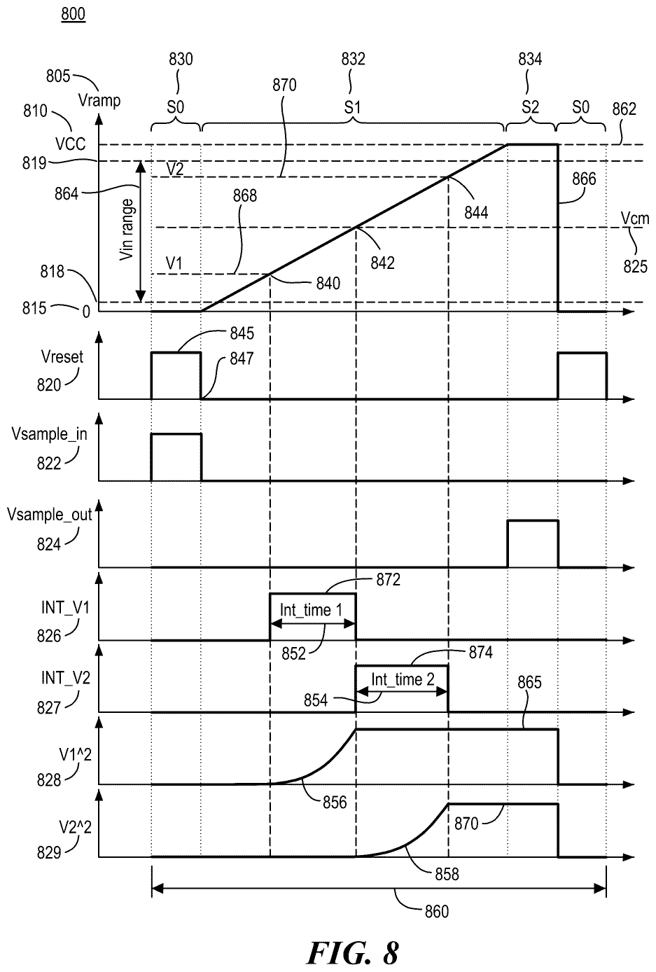

FIG. 8 shows graphs 800, including a graph 805 of an example voltage ramp signal, a graph 820 of an example reset signal, a graph 822 of an example input sample signal, a graph 824 of an example output sample signal, graphs 826, 827 of example PWM time signals generated as a result of a voltage-to-time conversion process, and graphs 828, 829 of example signals resulting from a double integration of the PWM time signals, consistent with embodiments of the present disclosure. For example, graphs 800 illustrate how sampled amplitudes of sine and cosine curve signals may be converted into PWM signals, and how double integrations of a constant value of the PWM signals may be taken over the width (time) of the PWM signal, consistent with embodiments of the present disclosure. The Y-axes of the graphs correspond to voltage and the X-axes 860 of the graphs correspond to time. The graphs are aligned to show how the timing between different signals may align in the voltage to time conversion process.

Graph 805 illustrates a level of a power supply voltage to the voltage to time conversion circuitry (e.g., voltage to time conversion circuitry 470, voltage to time conversion circuitry 475, voltage-to-time conversion circuitry 545, voltage-to-time conversion circuitry 555) with dotted line 862. Although illustrated as VCC in FIG. 8, the power supply voltage may also be represented as VDD, as discussed previously. Although a power supply voltage (VCC) may not be shown for the other graphs, or for other circuits described in the figures, it should be appreciated that the power supply to the voltage to time conversion circuitry may be the same as the power supply to the other circuitries, such as magnetic field sensing elements 202, circuitry 208, circuitry 220, and output interface 233. Within circuitry 220, it should be appreciated that the power supply to the voltage to time conversion circuitry may be the same as the power supply to ZoH circuitries (e.g., ZoH circuitry 430, ZoH circuitry 435, ZoH circuitry 510, ZoH circuitry 530), double integration circuitries (e.g., Time\hat{ }2 circuitry 484, Time\hat{ }2 circuitry 486, double integration circuitry 565, double integration circuitry 575), and adding circuitry (e.g., adding circuitry 493, adding circuitry 585).

Graph 805 also shows dotted lines for an input voltage range 864 (represented in FIG. 8 as Vin_range), which may extend from a voltage 818 to a voltage 819. Input voltage range 864 may correspond to the range of voltages between which the sine curve signals and cosine curve signals oscillate, with voltage 819 representing a peak voltage of the sine and cosine curves and voltage 818 representing a valley voltage of the sin and cosine curves. For a system that processes a single sine curve signal and a single cosine curve signal (e.g., single-ended signals), voltage 818 may be greater than a ground reference potential 815 (e.g., 0 Volts) of the voltage to time conversion circuitry, and voltage 819 may be lower than the power supply voltage (VCC) to the voltage to time conversion circuitry, as shown in graph 805. In embodiments where differential signals are processed, such as in the examples discussed above with respect to FIG. 5, voltage 818 may be lower than a ground reference potential 815.

As shown in graph 805, a voltage ramp signal 866 may ramp from a starting voltage 815 (0 Volts in the example of FIG. 8) to an ending voltage 810 (VCC in the example of FIG. 8). Voltage ramp signal 866 may then return to the starting voltage and may again ramp from the starting voltage to the ending voltage. Voltage ramp signal 866 may ramp from the starting voltage to the ending voltage periodically, such that the voltage ramp may be compared with the sampled amplitudes of the sine and/or cosine curve signals. Voltage ramp signal 866 may correspond to signals 450, 455 (vramp) of system 400, signal 548, 558 (Vrampp) of system 500, and/or signals 549, 559 (Vrampn) of system 500. In embodiments where differential signals are processed (such as discussed with reference to FIG. 5), the starting voltage of voltage ramp signal 866 may be a negative power supply voltage (e.g., −VCC) and the ending voltage of voltage ramp signal 866 may be a positive power supply voltage (e.g., VCC), as previously discussed.

V1 868 represents an example sampled amplitude of the sine curve signal (i.e., r*sine(θ)), which may correspond, for example, to signal 440 (V1_zoh), signal 520 (SINP_zoh), or signal 521 (SINN_zoh). V2 870 represents an example sampled amplitude of the cosine curve signal (i.e., r*cos(θ)), which may correspond, for example, to signal 445 (V2_zoh), signal 540 (COSP_zoh), or signal 541 (COSN_zoh). Voltage ramp signal 866 may be compared with V2 870 and V1 868, such as through use of one or more comparators.

As mentioned previously, the sine and cosine curve signals may be periodically sampled and the squared modulus value may be obtained periodically, so that the squared modulus value may be monitored to adjust a gain of components in the sensor device and/or to identify one or more errors in the sensor device. Thus, voltage ramp signal 866 may ramp from the starting voltage to the ending voltage periodically, and the comparison with the sampled sine curve and cosine curve signals performed periodically, such as in accordance with a clock signal. That is, the signals shown in FIG. 8 may correspond to one cycle of a repeating process where amplitudes of sine and cosine curve signals are sampled and compared with the voltage ramp. At the beginning and/or end of the cycle, a reset signal (e.g., reset signal 420 or 425) or sample signal (e.g., sample signal 513) may cause amplitudes of the sine and cosine curve signals to be sampled, and may reset the voltages of voltage ramp signal 866 and the voltages of the PWM signals, to a logic low value (e.g., 0 Volts). Then, after voltages of the sine and cosine curve signals have been sampled, these voltages may be compared with the voltage ramp signal.

Graphs 800 are illustrated as having three different sections of the cycle. In section SO, a reset of the circuitries involved in the process (e.g., voltage to time conversion circuitries, double integration circuitries, and/or adding circuitry) is performed, and amplitudes of the sine curve signal and cosine curve signal are sampled by the ZoH circuitries. In section S1, voltage ramp 866 may ramp up from voltage 815 to voltage 810, the sampled amplitudes (e.g., V2 870, V1 868) may be compared to voltage ramp 866 and to a common mode voltage 825 to generate the PWM pulses (e.g., pulse 872, pulse 874), and the double integration of the pulses may be performed to get signals (e.g., signals 865, 870) representing the values resulting from the double integration for each of the pulses. In section S2, the signals representing the values resulting from the double integration for each of the pulses may be sampled by the adding circuitry and added, resulting in the squared modulus value. Section SO may then be entered again and the circuitry reset and new sample amplitudes taken, and the process repeated, so as to continually and periodically provide an updated squared modulus value.

Graph 820 shows an example reset signal (represented in graph 820 as vreset). As shown in graph 820, a reset signal may have a logic high level 845 at a beginning of the cycle to cause ZoH circuitries to obtain new sample amplitudes of the sine and cosine curve signals, and to reset circuitries (e.g., voltage to time conversion circuitry, double integration circuitry and/or adding circuitry). The reset signal may then be changed to a logic low level 847, and when the reset signal is low, voltage ramp 866 may ramp up from voltage 815 to voltage 810, the sampled amplitudes (e.g., V2 870, V1 868) may be compared to voltage ramp 866 and to a common mode voltage 825 to generate the PWM pulses (e.g., pulse 872, pulse 874), the double integration of the pulses may be performed to get signals (e.g., signals 865, 870) representing the values resulting from the double integration for each of the pulses, and the signals representing the values resulting from the double integration for each of the pulses may be sampled by the adding circuitry and added, resulting in the squared modulus value. The reset signal may then go to a high logic level again, resetting the circuitry and the voltage ramp, so that sample amplitudes of the sine and cosine curve signals may be taken again and the process may be repeated.

Graph 822 shows an example input sample signal (represented in graph 822 as Vsample_in). As shown in graph 822, an input sample signal may have a logic high level at a beginning of the cycle to acquire a new sample of the amplitudes of the sine and cosine curve signals. For example, the input sample signal may cause ZoH circuitries to sample the current amplitudes of the sine and cosine curve signals. Alternatively the input sample signal may be excluded and the samples may be triggered by the reset signal (e.g., by the rising edge of the reset signal).

Graph 824 shows an example output sample signal (represented in graph 824 as Vsample_out). As shown in graph 824, an output sample signal may have a logic high level at an end of a cycle to acquire the double integration values (e.g., V1\hat{ }2, V2\hat{ }2) and to cause double integration values to be added. For example, the output sample signal may cause the adding circuitry to acquire the double integration values and add them together to obtain the squared modulus value.

As previously discussed with respect to FIG. 6, FIG. 6 illustrates an approach of converting sampled voltages to time that may only work when both the sine and cosine curve signals are in the positive portions of their periods (i.e., above the offset voltages around which the sine and cosine curves oscillate). Graphs 805, 826, and 827 illustrate an approach that also utilizes a common mode voltage, which may allow for a voltage to time conversion when both the sine and cosine curves are in the positive portions of their periods, when the sine curve is in the positive portion of its period and the cosine curve is in the negative portion of its period, when the sine curve is in the negative portion of its period and the cosine curve is in the positive portion of its period, and when both the sine curve and the cosine curve are in the negative portions of their periods. That is, the approach utilizing the common mode voltage may allow for voltage to time conversion regardless of which of the four quadrants a complex number representing the magnetic field falls into at a given time, allowing for a squared modulus value to be obtained at any angle over 360 degrees of rotation of the target.

Common mode voltage 825 may be a reference voltage that is also compared with the sampled amplitudes of the sine and cosine curve signals. In some embodiments, common mode voltage 825 may be set to a voltage around which the sine and/or cosine curve signals oscillate (i.e., an offset voltage). In an ideal quiescent state where there is no magnetic field, the output voltage may ideally be half the supply voltage (VCC or VDD). In an ideal case, the sine and cosine curve signals may then oscillate around the voltage value that is half the supply voltage. For example, FIG. 3B shows an ideal case, where a supply voltage is 3.3 Volts, and the positive sine curve, negative sine curve, positive cosine curve, and negative cosine curve signals all oscillate around a voltage of 1.65 Volts, half the supply voltage. However, in a practical application, the offset voltage may deviate from half the supply voltage, due to factors such as the magnetic field applied by the target, imperfections in the magnet, errors in misplacing the sensor device with respect to the target, or manufacturing tolerances of components inside the sensor device, as just some examples.

In some embodiments, the offset voltage for the sine curve may be determined by detecting a voltage of a peak of the sine curve and a voltage of the valley of the sine curve, and then identifying a midpoint voltage between the peak voltage and the valley voltage as the offset voltage. This voltage may then be set as the common mode voltage for the sine curve signal processing path. Similarly, the offset voltage for the cosine curve may be determined by detecting a voltage of a peak of the cosine curve and a voltage of the valley of the cosine curve, and then identifying a midpoint voltage between the peak voltage and the valley voltage as the offset voltage. This voltage may then be set as the common mode voltage for the cosine curve signal processing path.

In embodiments where differential signals are processed (such as discussed with reference to FIG. 5), the common mode voltage may be 0V, as a sine curve that is a difference between the positive and negative differential sine curves will oscillate around a midpoint voltage of 0V, and a cosine curve that is a difference between the positive and negative differential cosine curves will oscillate around a midpoint voltage of 0V.

The sampled amplitudes of the sine and cosine curves may be compared to voltage ramp signal 866 and common mode voltage 825 to generate the PWM signals (e.g., signals 872, 874). For example, at the beginning of the cycle, the signals shown in graph 826 (INT_V1) and in graph 827 (INT_V2) may be set to a logic low value, such as by resetting the voltage to time conversion circuitry with a reset (e.g., Vreset) signal. Then, if the voltage of voltage ramp signal 866 exceeds the voltage of the sampled sine or cosine curve signal, the value of the corresponding signal in graph 826 or 827 may change state (i.e., if the logic level was low, then it becomes high, and if it was high, then it becomes low). And if the voltage of voltage ramp signal 866 exceeds common mode voltage 825, the value of the signals in graphs 826 and 827 may change state (i.e., if the logic level was low, it becomes high, and if it was high, then it becomes low).

Thus, looking at the examples in graphs 805 and 826, it can be seen that the voltage of voltage ramp signal 866 crosses the voltage of the sampled amplitude of the sine curve signal (V1) (e.g., signal 440 (V1_zoh), signal 520 (SINP_zoh), signal 521 (SINN_zoh)) at a time 840, causing the signal shown in graph 826 (e.g., signal 480 (INT_V1), signal 552 (Tsin)) to switch from a logic low level to a logic high level. Then, when the voltage of voltage ramp signal 866 crosses common mode voltage 825 at time 842, the signal shown in graph 826 switches from the logic high level back to the logic low level. The result is a PWM signal pulse 872 of time 852 (int_time 1).

Similarly, looking at the examples in graphs 805 and 827, it can be seen that the voltage of voltage ramp signal 866 crosses common mode voltage 825 at time 842, causing the signal shown in graph 827 (e.g., signal 482 (INT_V2), signal 562 (Tcos)) to switch from a logic low level to a logic high level. Then, the voltage of voltage ramp signal 866 crosses the voltage of the sampled amplitude of the cosine curve signal (V2) (e.g., signal 445 (V2_zoh), signal 540 (COSP_zoh), signal 541 (COSN_zoh)) at time 844, causing the signal shown in graph 827 to switch from the logic high level back to the logic low level. The result is a PWM signal pulse 874 of time 854 (int_time 2).

Using the above approach of comparing the sampled voltages of the sine and cosine curves to both a voltage of a voltage ramp and a common mode voltage allows for a voltage to time conversion when both the sine and cosine curves are in the positive portions of their periods, when the sine curve is in the positive portion of its period and the cosine curve is in the negative portion of its period, when the sine curve is in the negative portion of its period and the cosine curve is in the positive portion of its period, and when both the sine curve and the cosine curve are in the negative portions of their periods. That is, the approach utilizing the common mode voltage may allow for voltage to time conversion regardless of which of the four quadrants a complex number representing the magnetic field falls into at a given time, allowing a squared modulus value to be obtained at any angle over 360 degrees of rotation of the target. Essentially, the approach generates a time of the PWM signal based on an absolute value of an amplitude of the sampled voltage with respect to the common mode voltage, thereby allowing all four quadrants discussed above to be converted to a PWM signal that has a width proportional to the amplitude of the sampled amplitude with respect to the common mode voltage.

In some embodiments, as discussed above, differential sine and cosine curve signals may be received at the voltage to time conversion circuitries. For example, as shown in system 500 of FIG. 5, a voltage-to-time conversion circuitry 545 receives a sampled amplitude of a positive sine curve signal 512 as signal 520 (SINP_zoh) and a sampled amplitude of a negative sine curve signal 514 as signal 521 (SINN_zoh). Because the positive sine curve signal and the negative sine curve signal may both be offset by the same offset voltage, a difference between the sampled amplitude of the positive sine curve signal and the sampled amplitude of the negative cosine curve signal may be taken to account for the common mode voltage, thereby allowing all four quadrants discussed above to be converted to a PWM signal that has a width proportional to the amplitudes of the sampled amplitudes with respect to the common mode voltage.

For example, a positive sine curve signal may correspond to

$$SINP = 0.5 * A * sin ( θ ) + V C M \qquad Equation 25$$

and a negative sine curve signal may correspond to

$$SINN = - 0.5 * A * sin ( θ ) + V C M \qquad Equation 26$$

where SINP is the positive sine curve signal, SINN is the negative sine curve signal, A corresponds to the amplitude of the sine curve signal, θ corresponds to the rotation angle of the target, and VCM is the common mode offset voltage. Similarly, a positive cosine curve signal may correspond to

$$COSP = 0.5 * A * cos ( θ ) + V C M \qquad Equation 27$$

and a negative cosine curve may correspond to

$$COSN = - 0.5 * A * cos ( θ ) + V C M \qquad Equation 28$$

where COSP is the positive cosine curve signal and COSN is the negative cosine curve signal.

A sine curve signal may then correspond to

$$SIN = SINP - SINN = A * sin ( θ ) \qquad Equation 29$$

and a cosine signal may then correspond to

$$COS = COSP - COSN = A * cos ( θ ) \qquad Equation 30$$

where SIN is a single-ended (i.e., not differential) sine curve signal and COS is a single-ended (i.e., not differential) cosine curve signal.

When taking a difference between the differential signals, the common mode voltage cancels out. As a result, the common mode voltage in such a case may be set to zero, or not used at all (e.g., signals 550, 560 (Vcm) of system 500 may be set to 0 Volts). A positive signal voltage ramp signal (e.g., signals 548 (Vrampp), 558 (Vrrampp)) may then be compared with the sampled amplitude of the positive sine curve signal (e.g., signal 520 (SINP_zoh)) and the sampled amplitude of the positive cosine curve signal (e.g., signal 540 (COSP_zoh)), like described with respect to FIG. 6 for a single-ended sine curve signal and a single-ended cosine curve signal, thereby yielding a PWM signal pulse with a width representative of the sampled amplitude of the positive sine curve signal and a PWM signal pulse with a width representative of the sampled amplitude of the positive cosine curve signal. Similarly, a negative signal voltage ramp signal (e.g., signals 549 (Vrampn), 559 (Vrampn)) may be compared with the sampled amplitude of the negative sine curve signal (e.g., signal 521 (SINN_zoh)) and the sampled amplitude of the negative cosine curve signal (e.g., signal 541 (COSN_zoh)), thereby yielding a PWM signal pulse with a width representative of the sampled amplitude of the negative sine curve signal and a PWM signal pulse with a width representative of the sampled amplitude of the negative cosine curve signal.

Thus, the process may result in a conversion of the sampled amplitudes of the positive sine curve signal, the positive cosine curve signal, the negative sine curve signal, and the negative cosine curve signal, to time. As shown in Equation 29, a difference can then be taken between the times of the PWM signal pulses for the positive sine curve and the negative sine curve to get the PWM signal pulse for a single-ended sine curve, which may be output as signal 552 (Tsin). As shown in Equation 30, a difference can then be taken between the times of the PWM signal pulses for the positive cosine curve and the negative sine curve to get the PWM signal pulse for a single-ended cosine curve, which may be output as signal 562 (Tsin). In one embodiment, signal 552 may be generated by using an AND gate to AND the PWM signal pulses for the positive sine curve and the negative sine curve together, and signal 562 may be generated by using an AND gate to AND the PWM signal pulses for the positive cosine curve and the negative cosine curve together, though the disclosure is not so limited. As a result of the above process, all four quadrants of the sine and cosine curve signals discussed above may be converted to PWM signals that have widths proportional to the sampled amplitudes with respect to the common mode voltage.

Returning to FIG. 8, as the PWM pulse for the sine curve signal (e.g., signal 480 (INT_V1), signal 552 (Tsin)) is being generated, as shown in the example in graph 826, double integration circuitry (e.g., Time\hat{ }2 circuitry 484, double integration circuitry 565) may be simultaneously performing a double integration process (e.g., as previously discussed) on the PWM pulse to generate a signal with the double integrated value (e.g., signal 488, signal 571). An example is shown in graph 828, where the signal ramps up exponentially at 856 as the circuitry integrates the PWM pulse shown in graph 826, resulting in a voltage value 865. The voltage value (e.g., voltage value 865) may then be output from the double integration circuitry as the signal with the double integrated voltage value, when the output sample signal (see graph 824) goes to a logic high level.

Similarly, as the PWM pulse for the cosine curve signal (e.g., signal 482 (INT_V2), signal 562 (Tcos)) is being generated, as shown in the example in graph 827, double integration circuitry (e.g., Time\hat{ }2 circuitry 486, double integration circuitry 575) may be simultaneously performing a double integration process (e.g., as previously discussed) on the PWM pulse to generate a signal with the double integrated value (e.g., signal 490, signal 581). An example is shown in graph 829, where the signal ramps up exponentially at 858 as the circuitry integrates the PWM pulse shown in graph 827, resulting in a voltage value 870. The voltage value (e.g., voltage value 870) may then be output from the double integration circuitry as the signal with the double integrated voltage value when the output sample signal (see graph 824) goes to a logic high level.

Although it may not be clear from FIG. 8, it should be recognized that the amplitudes of the voltages of the double integrated values in graphs 828 and 829 will vary depending on the length of time of the corresponding PWM pulse being integrated. Accordingly, when the time of the PWM pulse is greater, the amplitude of the resulting double integrated voltage value will be greater, and when the time of the PWM pulse is less, the amplitude of the resulting double integrated voltage value will be less.

Graph 824 shows an example signal that may trigger a sampling of the double integrated voltage values by adding circuitry (e.g., adding circuitry 493, adding circuitry 585). For example, when voltage ramp signal 866 has reached its peak voltage 810 (VCC), the signal shown in graph 824 may change from a logic low level to a logic high level, causing the adding circuitry to sample the double integrated voltage values and to add them together. The result of the addition by the adding circuitry may be a signal 496 or 590, which may be a squared modulus value.

Although an analog implementation of double integration circuitry (e.g., Time\hat{ }2 circuitry 484, Time\hat{ }2 circuitry 486, double integration circuitry 565, double integration circuitry 575) was discussed above with respect system 700 of FIG. 7, the double integration process may also be performed digitally, in a digital domain. For example, instead of using system 700, double integration circuitry (e.g., Time\hat{ }2 circuitry 484, Time\hat{ }2 circuitry 486, double integration circuitry 565, double integration circuitry 575) may include a digital counter (e.g., in digital circuitry 230). The signal output from the voltage to time conversion circuitry (e.g., signal 480 (INT_V1), signal 482 (INT_V2), signal 552 (Tsin), signal 562 (Tcos)) may be received by the double integration circuitry, and input into an enable port of the digital counter. When the PWM pulse is at a high logic level, the digital counter may be enabled, and may count clock pulses from a clock received at another port of the digital counter. When the signal from the voltage to time conversion circuitry returns to a logic low level, the digital counter may stop being enabled, and counting of the clock pulses may stop. The number of clock pulses counted by the digital counter may be stored as a value (e.g., CNT_sin, CNT_cos) in a memory. A digital processor (e.g., controller 235) may then perform the following calculation to obtain the squared modulus value

$${r}^{2} = {CNT\_sin}^{2} + {CNT\_cos}^{2} \qquad Equation 31$$

where r² is the squared modulus value, CNT_sin is the number of clock pulses counted in a digital counter based on the enable signal output from the voltage to time conversion circuitry in the sine curve signal processing path (e.g., signal 480 (INT_V1), signal 552 (Tsin)), and CNT_cos is the number of clock pulses counted in a digital counter based on the enable signal output from the voltage to time conversion circuitry in the cosine curve signal processing path (e.g., signal 482 (INT_V2), signal 562 (Tcos)).

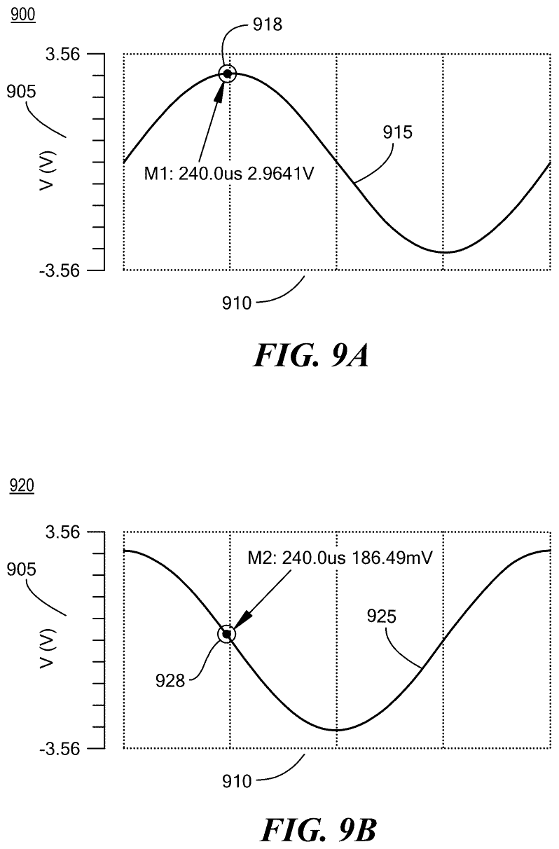

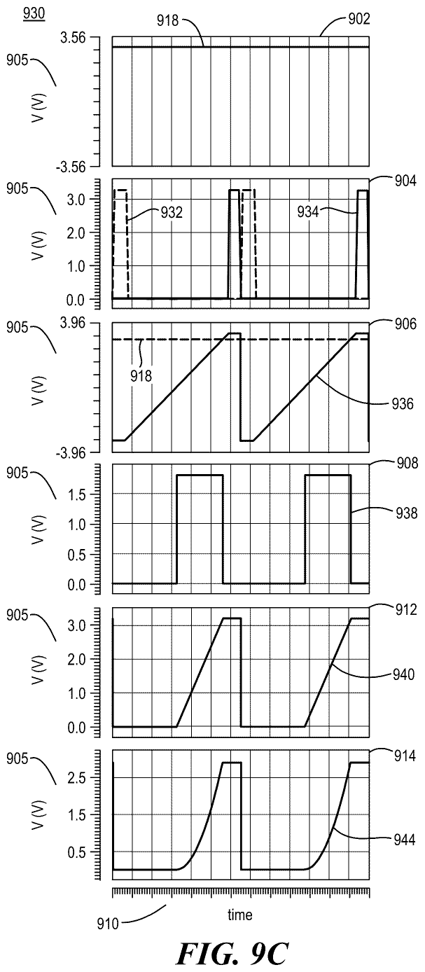

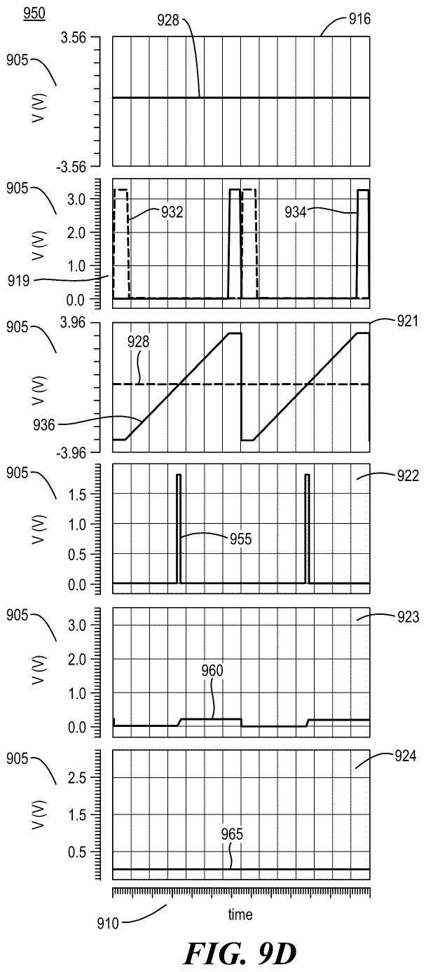

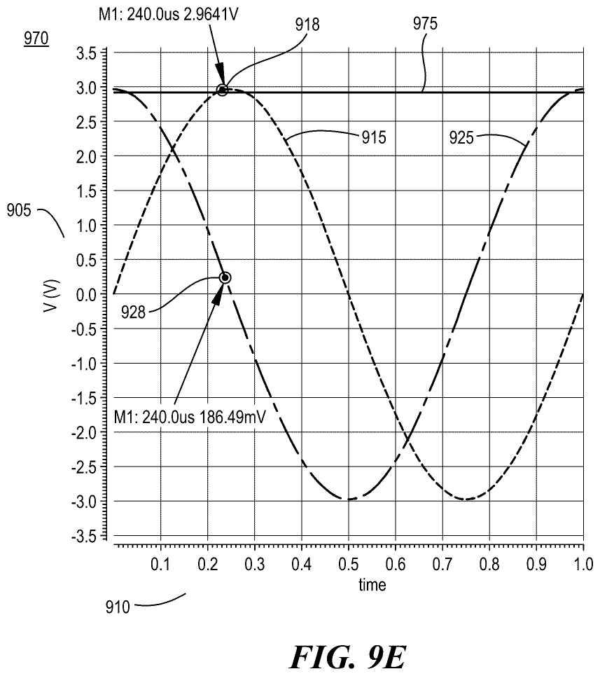

FIGS. 9A and 9B show graphs of example simulations of signals corresponding to a measured magnetic field by magnetic field sensing elements, and example simulated samples from the example signals. Each of FIGS. 9A and 9B have a Y-axis 905 corresponding to voltage (in Volts) and an X-axis corresponding to time 910.

For example, FIG. 9A shows a graph 900 of a simulation of an output sine curve signal 915 generated based on an output from one or more magnetic field sensing elements, as previously discussed herein. 918 corresponds to a sampled amplitude of the sine curve signal, such as by ZoH circuitry (e.g., ZoH circuitry 430, ZoH circuitry 510). As shown, the sampled amplitude in the example of FIG. 9A is 2.9641 Volts, which was sampled at 240.0 μs into the simulation.

FIG. 9B shows a graph 920 of an output cosine curve signal 925 generated based on an output from one or more magnetic field sensing elements, as previously discussed herein. 928 corresponds to a sampled amplitude of the cosine curve signal, such as by ZoH circuitry (e.g., ZoH circuitry 435, ZoH circuitry 530). As shown, the sampled amplitude in the example of FIG. 9B was sampled at the same time into the simulation as sample 918 (i.e., 240.0 μs), with a sampled amplitude of 186.49 millivolts (mV).

FIG. 9C shows graphs 930 of simulated signals generated from a simulation of the processing steps described herein, including a graph 902 of an amplitude of sample 918 from sine curve signal 915, a graph 904 of example signals for sampling sine curve signal 915 and for sampling an output signal, a graph 906 of voltage ramps and the amplitude of sample 918, a graph 908 of an example PWM time signal generated as a result of a voltage-to-time conversion process, a graph 912 of a signal resulting from a first integration of the example PWM time signal, and a graph 914 of a signal resulting from a second integration of the example PWM time signal.

Looking first at graph 902, 918 corresponds to sample 918 of FIG. 9A, held over time by a ZoH circuitry (e.g., ZoH circuitry 430, ZoH circuitry 510). That is, the voltage of 918 in graph 902 is 2.9641 Volts.

Graph 904 shows sample signal 932. When sample signal 932 goes to a logic high value, circuitry (e.g., voltage to time conversion circuitry, double integration circuitry) may be reset and the sine curve signal may be sampled, as can be seen from graphs 902, 906, 912, and 914. When sample signal 932 returns to the logic low level, the voltage ramp begins to ramp (see, e.g., graph 906) and the processing described above with respect to Section S1 of FIG. 8 may take place, as shown in graphs 906, 908, 912, and 914. Graph 904 also shows adding signal 934, which may correspond to signal 595 of FIG. 5, for example. When adding signal goes to a logic high value, the double integration value (see, e.g., signal 944) may be sampled by adding circuitry (e.g., adding circuitry 493, adding circuitry 585).

Graph 906 shows a voltage ramp signal 936 (e.g., signal 450 (vramp), signal 548 (Vrampp), signal 549 (Vrampn)) and the amplitude of sample 918 (e.g., signal 440 (V1_zoh), signal 520 (SINP_zoh), signal 521 (SINN_zoh)). In the example shown in FIG. 9C, voltage ramp signal 936 corresponds to a voltage ramp for a differential processing signal embodiment (such as discussed with reference to FIG. 5), and so voltage ramp signal 936 ramps from a negative starting voltage (e.g., −VCC) to a positive ending voltage (e.g., VCC).

Graph 908 shows a signal 938 with PWM pulses (e.g., signal 480 (INT_V1), signal 552 (Tsin)) that may be generated as a result of comparison of the voltage ramp signal with the amplitude of sample 918 and a common mode voltage signal (e.g., signal 460 (vcm), signal 550 (vcm)).

Graph 912 shows a signal 940 that may be generated as a result of performing a first integration of the PWM pulse of signal 938. For example, signal 940 may correspond to voltage Vlinear of system 700 of FIG. 7.

Graph 914 shows a signal 944 that may be generated as a result of performing a second integration of the PWM pulse of signal 938. For example, signal 944 may correspond to voltage Vsquare (or Vquadratic) of system 700 of FIG. 7, signal 488 of FIG. 4, and/or signal 571 of FIG. 5.

FIG. 9D shows graphs 950 of simulated signals generated from a simulation of the processing steps described herein, including a graph 916 of an amplitude of sample 928 from cosine curve signal 925, a graph 919 of example signals for sampling cosine curve signal 925 and for sampling an output signal, a graph 921 of voltage ramps and the amplitude of sample 928, a graph 922 of an example PWM time signal generated as a result of a voltage-to-time conversion process, a graph 923 of a signal resulting from a first integration of the example PWM time signal, and a graph 924 of a signal resulting from a second integration of the example PWM time signal.

Looking first at graph 916, 928 corresponds to sample 928 of FIG. 9B, held over time by a ZoH circuitry (e.g., ZoH circuitry 435, ZoH circuitry 530). That is, the voltage of 928 in graph 916 is 186.49 mV.

Graph 919 shows sample signal 932. When sample signal 932 goes to a logic high value, circuitry (e.g., voltage to time conversion circuitry, double integration circuitry) may be reset and the cosine curve signal may be sampled, as can be seen from graphs 916, 921, 923, and 924. When sample signal 932 returns to the logic low level, the voltage ramp may begin to ramp (see, e.g., graph 921) and the processing described above with respect to Section S1 of FIG. 8 may take place, as shown in graphs 921, 922, 923, and 924. Graph 919 also shows adding signal 934, which may correspond to signal 595 of FIG. 5, for example. When adding signal goes to a logic high value, the double integration value (see, e.g., signal 965) may be sampled by adding circuitry (e.g., adding circuitry 493, adding circuitry 585).

In some embodiments, sample signal 932 of FIG. 9C and sample signal 932 of FIG. 9D may be the same sample signal, adding signal 934 of FIG. 9C and adding signal 934 of FIG. 9D may be the same adding signal, and voltage ramp signal 936 of FIG. 9C and voltage ramp signal 936 of FIG. 9D may be the same voltage ramp signal.

Graph 921 shows a voltage ramp signal 936 (e.g., signal 455 (vramp), signal 558 (Vrampp), signal 559 (Vrrampn)) and the amplitude of sample 928 (e.g., signal 445 (V2_zoh), signal 540 (COSP_zoh), signal 541 (COSN_zoh)). In the example shown in FIG. 9D, voltage ramp signal 936 corresponds to a voltage ramp for a differential processing signal embodiment (such as discussed with reference to FIG. 5), and so voltage ramp signal 936 ramps from a negative starting voltage (e.g., −VCC) to a positive ending voltage (e.g., VCC).

Graph 922 shows a signal 955 with PWM pulses (e.g., signal 482 (INT_V2), signal 562 (Tcos)) that may be generated as a result of comparison of the voltage ramp signal with the amplitude of sample 928 and a common mode voltage signal (e.g., signal 465 (vcm), signal 560 (vcm)).

Graph 923 shows a signal 960 that may be generated as a result of performing a first integration of the PWM pulse of signal 955. For example, signal 960 may correspond to voltage Vlinear of system 700 of FIG. 7.

Graph 924 shows a signal 965 that may be generated as a result of performing a second integration of the PWM pulse of signal 955. For example, signal 965 may correspond to voltage Vsquare (or Vquadratic) of system 700 of FIG. 7, signal 490 of FIG. 4, and/or signal 581 of FIG. 5.

It should be appreciated that the sine and cosine curve signals may be processed by the parallel signal processing paths simultaneously. For example, to get the squared modulus value for a particular rotation angle of the target, the amplitudes of the sine curve signal and cosine curve signal must be sampled at the same time, or substantially the same time, as shown in FIGS. 9A and 9B. The parallel processing paths may then process the sampled amplitudes simultaneously, such that the double integration value corresponding to the sampled sine curve amplitude and the double integration value corresponding to the sampled cosine curve amplitude are available to be sampled by the adding circuitry at the same time when the adding signal is received. The adding circuitry (adding circuitry 493, adding circuitry 585) may then sample the double integration values and add them together, outputting the sum as signal 590, which corresponds to the squared modulus value for the particular rotation angle of the target. That is, the adding circuitry would sample the amplitudes of signals 944 and 965 at the times shown in graphs 904, 919 when the adding signal is at a logic high value, and then would add those amplitudes to obtain the squared modulus value.

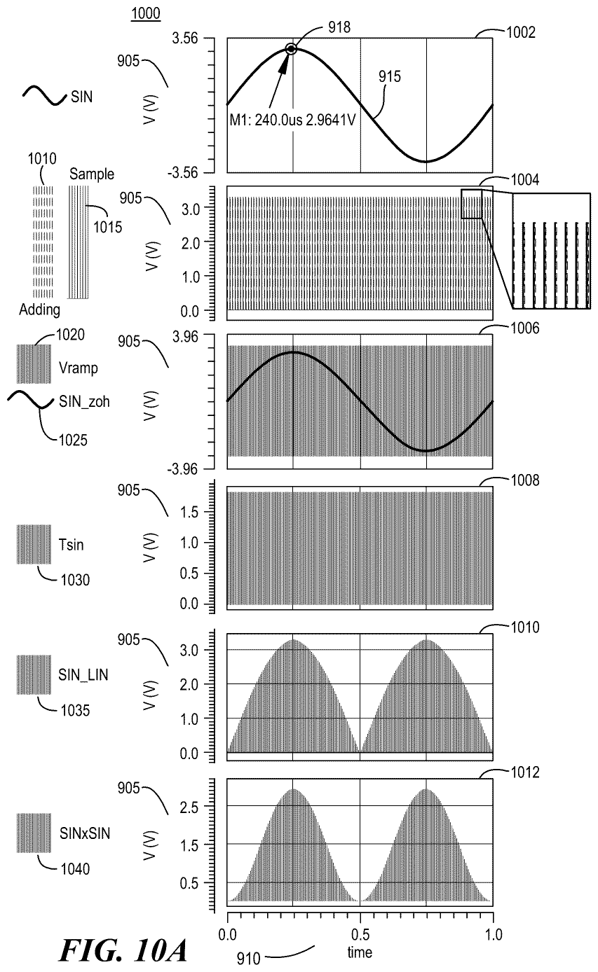

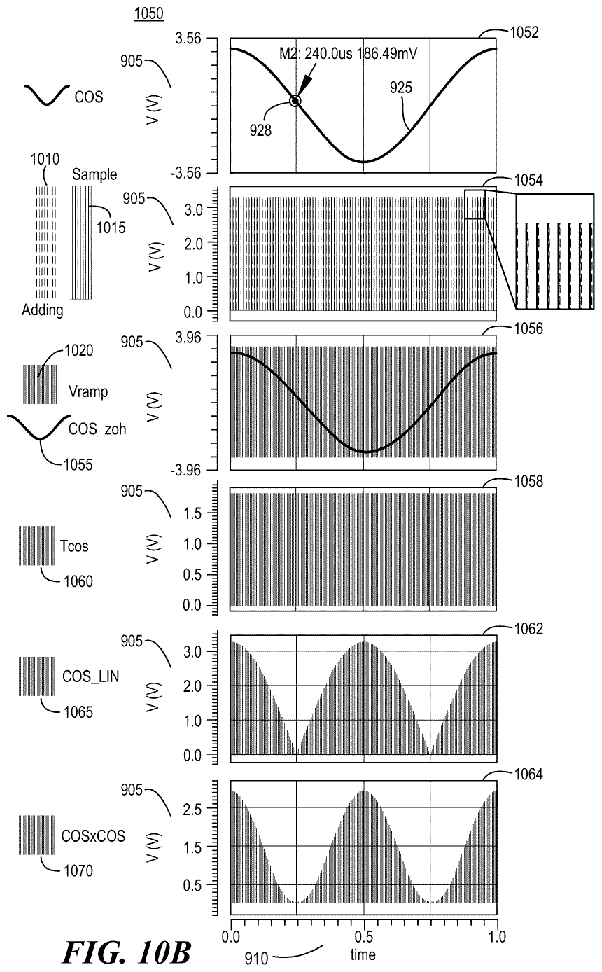

FIG. 9E shows a graph 970 of the simulated sine curve signal of FIG. 9A and the sample from the simulated sine curve signal, the simulated cosine curve signal of FIG. 9B and the sample from the simulated cosine curve signal, and squared modulus values 975 that were obtained by simulating the processing steps described herein. Repeated cycles of the processing steps were simulated (see FIGS. 10A and 10B), and as shown in FIG. 9E, the squared modulus value did not change over 360 degrees of rotation of the target. This is as expected, as the overall complex magnitude of the magnetic field generated by the target should not change based on the rotation angle of the target assuming the sensor device is positioned correctly. Of course, in practical applications, some nonlinearities may occur due to misplacement of the sensor device, imperfections in the target, manufacturing tolerances of components in the sensor device, and the like. Nevertheless, the squared modulus value can be expected to remain substantially constant over time and rotation angle, absent errors in the system.

FIG. 10A shows graphs 1000 of simulated signals, including a graph 1002 of a sine curve signal corresponding to a measured magnetic field by one or more magnetic field sensing elements and a sample from the sine curve signal, a graph 1004 of example signals for sampling the sine curve signal and for sampling output signals, a graph 1006 of voltage ramps and sampled amplitudes of the sine curve signal, a graph 1008 of example PWM time signals generated as a result of voltage-to-time conversion processes, a graph 1010 of signals resulting from first integrations of the PWM time signals, and a graph 1012 of signals resulting from second integrations of the PWM time signals.

Graph 1002 corresponds to graph 900 of FIG. 9A, which shows a sine curve signal 915 corresponding to 360 degrees of rotation of a target.

Graph 1004 shows sample signals 1015 and adding signals 1010, as discussed above with respect to graph 904 of FIG. 9A, but occurring repeatedly over time as a target rotates 360 degrees. It should be appreciated that, using the processes described herein, a sine curve signal may be repeatedly sampled at high speed, and double integration values may be repeatedly sampled at high speed, as shown in graph 1004, to repeatedly obtain and output a squared modulus value.

Graph 1006 shows a voltage ramp signal 1020 (e.g., Vramp) over time and sampled amplitudes of the sine curve signal (e.g., SIN_zoh) over time, as the target rotates 360 degrees. It should be appreciated that, using the processes described herein, a sine curve signal may be repeatedly sampled at high speed, and a voltage signal may ramp repeatedly at high speed, such that PWM signals are repeatedly generated and used to perform the double integration and adding processes, and to thereby repeatedly obtain and output a squared modulus value.

Graph 1008 shows a signal 1030 (e.g., Tsin) with PWM pulses over time, as the target rotates 360 degrees. It should be appreciated that, using the processes described herein, PWM pulses may be repeatedly generated at high speed and used to perform the double integration and adding processes, thereby repeatedly obtaining and outputting a squared modulus value.

Graph 1010 shows a signal 1035 (e.g., SIN_LIN) that may be generated as a result of performing first integrations of the PWM pulses of signal 1030 over time, as the target rotates 360 degrees.

Graph 1012 shows a signal 1040 (e.g., SIN×SIN) that may be generated as a result of performing second integrations of the PWM pulses of signal 1030 over time, as the target rotates 360 degrees. It should be appreciated that, using the processes described herein, the double integration values may be obtained repeatedly at high speed and used in the adding process to repeatedly obtain and output a squared modulus value.

FIG. 10B shows graphs 1050 of simulated signals, including a graph 1052 of a cosine curve signal corresponding to a measured magnetic field by one or more magnetic field sensing elements and a sample from the cosine curve signal, a graph 1054 of example signals for sampling the cosine curve signal and for sampling output signals, a graph 1056 of voltage ramps and sampled amplitudes of the cosine curve signal, a graph 1058 of example PWM time signals generated as a result of voltage-to-time conversion processes, a graph 1062 of signals resulting from first integrations of the PWM time signals, and a graph 1064 of signals resulting from second integrations of the PWM time signals.

Graph 1052 correspond to graph 920 of FIG. 9B, which shows a cosine curve signal 925 corresponding to 360 degrees of rotation of a target.

Graph 1054 shows sample signals 1015 and adding signals 1010, as discussed above with respect to graph 919 of FIG. 9B, but occurring repeatedly over time as a target rotates 360 degrees. It should be appreciated that, using the processes described herein, a cosine curve signal may be repeatedly sampled at high speed, and double integration values may be repeatedly sampled at high speed, as shown in graph 1054, to repeatedly obtain and output a squared modulus value.

Graph 1056 shows a voltage ramp signal 1020 (e.g., Vramp) over time and sampled amplitudes of the cosine curve signal (e.g., COS_zoh) over time, as the target rotates 360 degrees. It should be appreciated that, using the processes described herein, a cosine curve signal may be repeatedly sampled at high speed, and a voltage signal may ramp repeatedly at high speed, such that PWM signals are repeatedly generated and used to perform the double integration and adding processes, and to thereby repeatedly obtain and output a squared modulus value.

Graph 1058 shows a signal 1060 (e.g., Tcos) with PWM pulses over time, as the target rotates 360 degrees. It should be appreciated that, using the processes described herein, PWM pulses may be repeatedly generated at high speed and used to perform the double integration and adding processes, thereby repeatedly obtaining and outputting a squared modulus value.

Graph 1062 shows a signal 1065 (e.g., COS_LIN) that may be generated as a result of performing first integrations of the PWM pulses of signal 1060 over time, as the target rotates 360 degrees.

Graph 1064 shows a signal 1070 (e.g., COS×COS) that may be generated as a result of performing second integrations of the PWM pulses of signal 1060 over time, as the target rotates 360 degrees. It should be appreciated that, using the processes described herein, the double integration values may be obtained repeatedly at high speed and used in the adding process to repeatedly obtain and output a squared modulus value.

The squared modulus values corresponding to the sampled sine and cosine curve signals may be repeatedly added by adding circuitry in response to an adding signal (see graphs 1004, 1054), and thus the squared modulus may be repeatedly obtained and output at high speed over time. Graph 970 shows the squared modulus value 975 over time based on simulations of the processes described herein and the signals shown in FIGS. 10A and 10B. That is, squared modulus value 975 is the result of summing signals 1040 and 1070 of FIGS. 10A and 10B, respectively. As shown, the squared modulus is constant over time. As previously discussed, this is as expected, as the overall complex magnitude of the magnetic field generated by the target should not change based on the rotation angle of the target assuming the sensor device is positioned correctly. Of course, in practical applications, some nonlinearities may occur due to misplacement of the sensor device, imperfections in the target, manufacturing tolerances of components in the sensor device, and the like. Nevertheless, the squared modulus value can be expected to remain substantially constant over time and rotation angle, absent errors in the system.

As previously discussed, the squared modulus value may be proportional to the complex magnitude of the magnetic field sensed by the sensor device. The processes described herein in obtaining the squared modulus value may be advantageous over other approaches for obtaining a value representative of the complex magnitude of a magnetic field. For example, as discussed above, the processes described herein compensate for the voltage offset around which the sine curve and cosine curve signals oscillate.

Once the squared modulus value has been obtained, it may be used by the sensor device to adjust the gain of one or more components of the sensor device. For example, the sensor device may automatically adjust a gain of one or more amplifiers in the sine and/or cosine curve signal generation signal paths (e.g., amplifier 206A, amplifier 206B, amplifier 255A, amplifier 255B, amplifier 255C, amplifier 265A, amplifier 265B) such that the sensor obtains and may output a squared modulus value having a desired amplitude, a sine curve signal having a desired amplitude, and/or a cosine curve signal having a desired amplitude. Alternatively, as previously discussed, the sensor device may output the squared modulus value to an external system (e.g., computing system(s) 1230 of FIG. 12, computing device(s) 1310 of FIG. 13), and the external system may send a signal back to the sensor device that causes the sensor device to adjust the gain of one or more components within the sensor device based on the squared modulus value.

Allowing for gain adjustment, such as automatic gain adjustment (AGC), may be advantageous in reducing the amount of time it might take to calibrate a sensor device in a system. For example, rather than having to readjust placement of a sensor device with respect to a target to obtain desired amplitudes for the sine curve, cosine curve, and/or squared modulus signals, the sensor device and/or an external system may adjust the gain of components within the sensor device to achieve the desired magnitudes, such that readjustment of the positioning of the sensor device is not required. Moreover, because the squared modulus value does not change over time (as previously discussed), the squared modulus value may be obtained regardless of whether the target is rotated or not. Thus, gain adjustments may be made without having to operate the system to make the target rotate, thereby further speeding up system set up time.

A sensor device and/or external system may also use the obtained squared modulus values to implement safety mechanisms. For example, watchdog circuitry and/or software may monitor the PWM signals corresponding to the sampled sine and cosine curve signals discussed herein to determine whether they are at a logic low level at the same time. So long as a sufficient magnetic field is generated by the target and the sensor device is positioned in proximity to the target, the PWM signals corresponding to the sampled sine and cosine curve signals should not be logic low (or “0”) at the same time. Thus, if it is detected that these PWM signals are logic low (or “0”) at the same time, an error condition may be triggered in the sensor device and/or external system. For example, an error condition signal may be transmitted from the sensor device to an external system to inform the external system of the error. When both PWM signals are logic low (or “0”) at the same time, the error condition may indicate that the target is absent, or that the sensor device has moved and it no longer positioned adjacent the target, as just some examples. As another example, the sensor device and/or external system may store threshold voltage values that the voltage of the squared modulus signal should not exceed, and the squared modulus signal may be compared with these threshold voltage values. For example, if the voltage of the squared modulus value exceeds a predetermined maximum threshold voltage value, an error condition may be detected which may indicate, for example, that the magnetic field sensing elements or processing circuitry are saturated by the strength of the magnetic field generated by the target, and so the sine and cosine curve values output from the sensor device cannot be trusted. Alternatively, if the voltage of the squared modulus signal is below a predetermined minimum threshold voltage value, an error condition may be detected which may indicate, for example, that the sensor device is positioned too far from the target, that the target is absent, or that one or more components within the sensor device have failed, and that therefore the sine and cosine curve values output from the sensor device cannot be trusted.

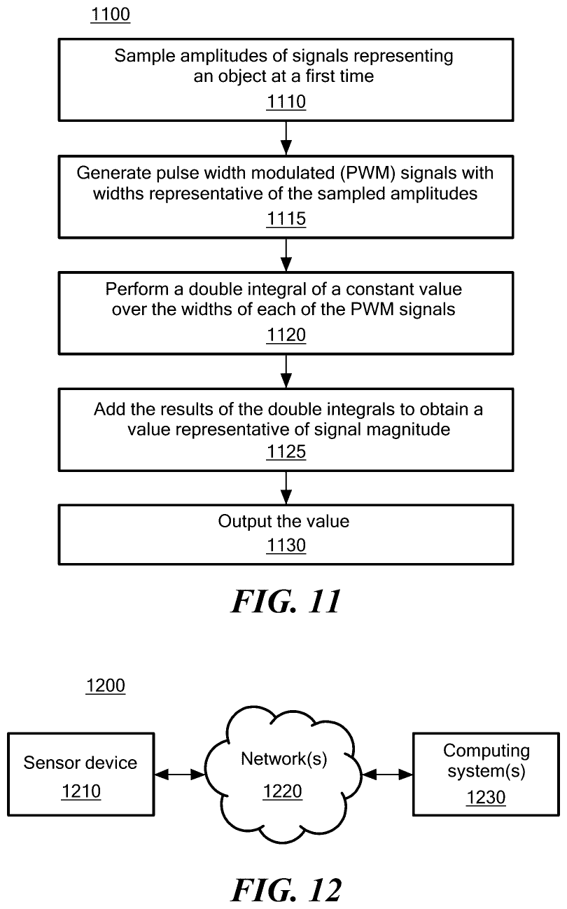

FIG. 11 shows an example process 1100 for obtaining a representation of magnitude of a magnetic field as sensed by a sensor device, consistent with embodiments of the present disclosure. The representation of magnitude of the magnetic field as sensed by the sensor device may be a squared modulus value, as previously discussed herein. Process 1100 may be performed, for example, in circuitry 220 of sensor device 205 or sensor device 245, such as by system 400 or 500. In some embodiments, process 1100 may be performed by a processor in an external system (e.g., computing system(s) 1230 of FIG. 12, computing device(s) 1310 of FIG. 13) executing instructions stored in a memory.

In 1110, amplitudes of signals representing an object at a first time may be sampled. For example, as previously discussed herein, ZoH circuitry (e.g., ZoH circuitry 430, ZoH circuitry 435, ZoH circuitry 510, ZoH circuitry 530) may sample amplitudes of a sine curve signal and a cosine curve signal at the same first time, the sine curve signal and cosine curve signals representing the magnetic field of the target.

In 1115, PWM signals may be generated, with widths of the PWM signals being representative of the sampled amplitudes of the sine curve signal and the cosine curve signal. For example, as previously discussed herein, voltage to time conversion circuitry (e.g., voltage to time conversion circuitry 470, voltage to time conversion circuitry 475, voltage-to-time conversion circuitry 545, voltage-to-time conversion circuitry 555) may generate PWM signals corresponding to the sampled amplitudes of the sine and cosine curve signals by comparing the sampled amplitudes with a voltage ramp signal and a common mode voltage signal.

In 1120, double integrations of a constant value may be performed over the widths of the PWM signals. For example, as previously discussed, double integration circuitry (e.g., Time\hat{ }2 circuitry 484, Time\hat{ }2 circuitry 486, double integration circuitry 565, double integration circuitry 575, system 700, digital circuitry including digital counter) may perform double integrations of the generated PWM signals.

In 1125, results of the double integrations may be added to obtain a value representative of the magnitude of the magnetic field as sensed by the sensor device. For example, as previously discussed, results of the double integrations may be added by adding circuitry (e.g., adding circuitry 493, adding circuitry 585) to obtain a squared modulus value, which is representative of the magnitude of the magnetic field as sensed by the sensor device.

In 1130, the obtained value representative of the magnitude of the magnetic field as sensed by the sensor device may be output. For example, the value may be output to circuitry (e.g., circuitry 220) and/or a controller (e.g., controller 235), such that the circuitry or controller may utilize the value to make gain adjustments to components of the sensor device or to detect whether an error condition has occurred. As another example, the value may be output over an output interface (e.g., output interface 233) to an external system (e.g., computing system(s) 1230 of FIG. 12, computing device(s) 1310 of FIG. 13), which may be used by the external system to make gain adjustments to components of the sensor device or to detect error conditions, as just some examples.

FIG. 12 is a block diagram of an example computing environment for implementing embodiments of the present disclosure, in accordance with some embodiments. For example, a sensor device 1210 (e.g., sensor device 205, sensor device 245) may output an obtained squared modulus value over one or more networks 1220 to one or more computing system(s) 1230. As previously discussed, computing system(s) 1230 may then use the squared modulus value to determine whether gain adjustments should be made to components of sensor device 1210, and may transmit a signal back to sensor device 1210 over network(s) 1220 to affect the gain adjustments. Additionally, as discussed above, computing system(s) 1230 may monitor the squared modulus value output from the sensor device to determine, for example, whether sensor device 1210 is appropriately calibrated within a system (e.g., properly positioned in proximity to a target) or whether an error condition has occurred.

As previously discussed, sensor device 1210 may output the sine and cosine curve signals generated within the sensor device, such as single-ended and/or differential sine and cosine curve signals, to computing system(s) 1230. Computing system(s) 1230 may then use the sine and cosine curve signals to calculate an angle of rotation of a target, such as by using the two-argument arctangent function a tan 2, commonly used in computing and mathematics, as previously discussed. Various other techniques may be used by computing system(s) 1230 to determine a measured rotation angle of the target instead of using an inverse tangent function, such as by using a lookup table, a polynomial fit, or a coordinate rotation digital computer (CORDIC) calculation. Performing these calculations in an external system, such as in computing system(s) 1230, may be advantageous in that sensor device 1210 may not require components that may take up more space, be less power efficient, be slower, and/or be more costly. As a result, sensor device 1210 may be more compact, more power efficient, faster, and less expensive.

In some embodiments, a sensor device 1210 may be further simplified to only have magnetic field sensing elements 202 and circuitry 208, and may output sine and cosine curve signals from circuitry 208 to an external system, such as computing system(s) 1230. Computing system(s) 1230 may then perform process 1100 using the sine and cosine curve signals, such as by processing the signals through analog circuitry 220 (as discussed above), or through a digital implementation using digital counters, as discussed above. In some embodiments, computing system(s) 1230 may store instructions for calculating the squared modulus value based on the sine and cosine curve signals using process 1100, and a controller of computing system(s) 1230 may obtain the squared modulus value by executing the instructions stored in the memory to perform process 1100. Alternatively, certain aspects of process 1100 may be performed in sensor device 1210, and other aspects of process 1100 may be performed in computing system(s) 1230. For example, sensor device 1210 may sample the sine and cosine curve signals and output the sampled amplitudes, such that computing system(s) 1230 may perform the remaining steps of process 1100. As another example, sensor device 1210 may generate the PWM signals using the voltage-to-time conversion processes described herein and output the PWM signals, such that the remaining steps may be performed in computing system(s) 1230.

Network(s) 1220 may include, for example, one or more wired and/or wireless networks. By way of example, the network(s) 1220 may include one or more conductor over which current signals may be transmitted, one or more conductors over which voltage signals may be transmitted, an Inter-Integrated Circuit (I₂C) network, a Controller Area Network (CAN) network, a WiFi network, an Ethernet network, a Universal Serial Bus (USB) network, a local area network (LAN) network, a cellular (e.g., 5G) network, and/or any other suitable type of network.

Computing system(s) 1230 may include one or more computing devices (see, e.g., computing device 1310 of FIG. 13). A computing device may be, for example, a computing device that may be used to perform some or all of process 1100 of FIG. 11. Alternatively, a computing device may be a computing device that may be programmed to perform certain actions (e.g., monitoring, gain adjustment, error checking actions) based on receipt of a squared modulus value, and/or that may calculate an angle of rotation based on sine curve and cosine curve signals transmitted from sensor device 1210. For example, rather than having to include a controller or processor with significant processing ability (and perhaps large size and/or high cost) in a sensor device, a less sophisticated controller or circuitry may be included in a sensor device and signals sent to another computing device such that the other computing device may perform the more complicated and processor-intensive tasks. A computing device 1310 may be, for example, an integrated circuit connected to a sensor device. Alternatively, a computing device 1310 may be a computer, such as a laptop computer, mobile phone, tablet, personal computer, server computer, or other type of computer.

FIG. 13 is a block diagram 1300 of a computing device 1310, consistent with embodiments of the present disclosure. As shown in FIG. 13, a computing device 1310 may include one or more processors or controllers 1320 for executing instructions. Processors or controllers suitable for the execution of instructions may include, by way of example, both general and special purpose (e.g., application specific integrated circuit (ASIC) processors or controllers. A computing device 1310 may also include one or more input/output (I/O) devices 1330. By way of example, I/O devices 1330 may include keys, buttons, mice, joysticks, styluses, etc. Keys and/or buttons may be physical and/or virtual (e.g., provided on a touch screen interface). A computing device 1310 may be connected to one or more displays (not shown) via I/O 1330. A display may be implemented using one or more display panels, which may include, for example, one or more cathode ray tube (CRT) displays, liquid crystal displays (LCDs), plasma displays, light emitting diode (LED) displays, touch screen type displays, organic light emitting diode (OLED) displays, or any other type of suitable display.

A computing device 1310 may include one or more storage devices configured to store data and/or software instructions used by processor(s) or controller(s) 1320 to perform operations consistent with disclosed embodiments. For example, computing device 1310 may include main memory 1340 configured to store one or more software programs that, when executed by processor(s) or controller(s) 1320, cause processor(s) or controller(s) 1320 to perform functions or operations consistent with disclosed embodiments.

By way of example, main memory 1340 may include NOR and/or NAND flash memory devices, read only memory (ROM) devices, random access memory (RAM) devices, etc. A computing device 1310 may also include one or more storage mediums 1350. By way of example, storage medium(s) 1350 may include hard drives, solid state drives, etc. A computing device 1310 may include any number of main memories 1340 and storage mediums 1350. A main memory 1340 or storage medium 1350 may, in some embodiments, be a non-transitory computer-readable medium.

A computing device 1310 may further include one or more communication interfaces 1360. Communication interface(s) 1360 may allow one or more signals to be received from a sensor device (e.g., sensor device 1210, sensor device 300) over one or more networks 1220, and may allow one or more signals to be transmitted to the sensor device. Example communication interface(s) 1360 include a modem, network interface card (e.g., Ethernet card), communications port, antenna, conductor over which current signals may be transmitted, an Inter-Integrated Circuit (I₂C) interface, a Controller Area Network (CAN) network interface, a WiFi interface, an Ethernet a Universal Serial Bus (USB) interface, a local area network (LAN) network interface, a cellular (e.g., 5G) interface, and/or any other suitable type of interface for transmitting and/or receiving signals or other information. Communication interface(s) 1360 may transmit software, data, or information in the form of signals, which may be electronic, electromagnetic, optical, and/or other types of signals. The signals may be provided to/from communications interface 1360 via a communications path (e.g., network(s) 1220), which may be implemented using wired, wireless, cable, fiber optic, radio frequency (RF), and/or other communications channels.

Although certain actions are described herein as occurring upon receipt of a logic high level signal or a logic low level signal, one of skill in the art would recognize that the actions may be triggered based on another type of signal (e.g., a logic low level signal instead of a logic high level signal, or vice versa). The specific examples described herein, and shown in the figures, were provided by way of illustration and explanation only, and should not be regarded as limiting.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the systems and methods are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described with reference to one embodiment, knowledge of one skilled in the art may be relied upon to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method of obtaining a value representative of magnetic field strength, comprising:
sampling amplitudes of a plurality of signals representing a magnetic field associated with a target at a first time;
generating pulse width modulated (PWM) signals with widths representative of the sampled amplitudes;
performing a double integration of a constant value over the widths of each of the PWM signals;
adding results of the double integrations to obtain a value representative of a magnitude of the magnetic field strength; and
outputting the value.

2. The method of claim 1, further comprising sampling the amplitudes of the plurality of signals with zero order hold circuits.

3. The method of claim 1, wherein the PWM signals are generated by comparing the sampled amplitudes with one or more voltage ramp signals.

4. The method of claim 1, wherein the double integrations are performed by one or more circuits, the one or more circuits comprising capacitors, a current source, a transconductance component, and a plurality of switches.

5. The method of claim 1, wherein the double integrations are performed digitally by a digital controller.

6. The method of claim 1, wherein the double integrations are performed simultaneously with the generation of the PWM signals.

7. The method of claim 1, further comprising receiving a signal to adjust a gain of the plurality of signals in response to the value.

8. The method of claim 1, further comprising outputting an error signal when an amplitude of each of the PWM signals is zero at the same time.

9. The method of claim 1, further comprising outputting an error signal when the obtained value is either greater than a first predetermined value or less than a second predetermined value.

10. The method of claim 3, further comprising setting a common mode reference voltage.

11. The method of claim 10, wherein the PWM signals are further generated by comparing the one or more voltage ramp signals with the common mode reference voltage.

12. A system comprising electronic circuitry configured to:
sample amplitudes of a plurality of signals representing a magnetic field associated with a target at a first time;
generate pulse width modulated (PWM) signals with widths representative of the sampled amplitudes;
perform a double integration of a constant value over the widths of each of the PWM signals;
add results of the double integrations to obtain a value representative of a magnitude of a strength of the magnetic field; and
output the value.

13. The system of claim 12, wherein the electronic circuitry further comprises zero hold circuits configured to sample the amplitudes of the plurality of signals.

14. The system of claim 12, wherein the electronic circuitry further comprises voltage-to-time conversion circuits configured to compare the sampled amplitudes with one or more voltage ramp signals to generate the PWM signals.

15. The system of claim 12, wherein the electronic circuitry further comprises one or more circuits configured to perform the double integrations, the one or more circuits comprising capacitors, a current source, a transconductance component, and a plurality of switches.

16. The system of claim 12, wherein the electronic circuitry further comprises a digital controller, the digital controller configured to perform the double integrations.

17. The system of claim 12, wherein the electronic circuitry is further configured to receive a signal to adjust a gain of the plurality of signals in response to the value.

18. The system of claim 12, wherein the electronic circuitry is further configured to cause an error signal to be output when an amplitude of each of the PWM signals is zero at the same time.

19. The system of claim 12, wherein the electronic circuitry is further configured to cause an error signal to be output when the obtained value is either greater than a first predetermined value or less than a second predetermined value.

20. The system of claim 12, wherein the electronic circuitry is further configured to set a common mode reference voltage.

21. The system of claim 20, wherein the electronic circuitry is further configured to generate the PWM signals by comparing the one or more voltage ramp signals with the common mode reference voltage.

22. A non-transitory computer-readable medium storing instructions that, when executed by a processor, configure the processor to:
receive pulse width modulated (PWM) signals with widths representative of a magnitude of a magnetic field of a target;
perform a double integration of a constant value over the widths of each of the PWM signals;
add results of the double integrations to obtain a value representative of a magnitude of a strength of the magnetic field; and
output the value.

23. The non-transitory computer-readable medium of claim 22, wherein the processor is further configured to perform the double integrations.

24. The non-transitory computer-readable medium of claim 22, wherein the processor is further configured to output an error signal when an amplitude of each of the PWM signals is zero at the same time.

25. The non-transitory computer-readable medium of claim 22, wherein the processor is further configured to output an error signal when the obtained value is either greater than a first predetermined value or less than a second predetermined value.
